(19) United States
(12) Patent Application Publication
(10) Pub. No.: US 2012/0241390 A1
(43) Pub. Date: Sep. 27, 2012

(54) BITUMEN EXTRACTION AND ASPHALTENE REMOVAL FROM HEAVY CRUDE USING HIGH SHEAR

(75) Inventors: Abbas Hassan, Sugar Land, TX (US); Aziz Hassan, Sugar Land, TX (US); Krishnan Viswanathan, Houston, TX (US); Gregory G. Borsinger, Chatham, NJ (US); Rayford G. Anthony, College Station, TX (US)

(73) Assignee: H R D CORPORATION, Houston, TX (US)

(21) Appl. No.: 13/434,288

(22) Filed: Mar. 29, 2012

Related U.S. Application Data
(63) Continuation of application No. 12/914,781, filed on Oct. 28, 2010.
(60) Provisional application No. 61/262,027, filed on Nov. 17, 2009.

(51) Int. Cl. C10G 1/00; C10G 1/04; C02F 1/00; C02F 101/32; C02F 101/10

(52) U.S. Cl. 210/806; 208/390; 196/46; 210/512.3; 210/257.1

(57) ABSTRACT

Herein disclosed is a method of removing at least one component from a feed stream, the method including steps of subjecting the feed stream to high shear separation in a high shear device to produce a high shear-treated product stream; and substantially separating the at least one component from the high shear-treated product stream to produce a component-reduced product stream.

### CROSS-REFERENCE TO RELATED APPLICATIONS

This application is a continuation application of U.S. Ser. No. 12/914,781 filed on Oct. 28, 2010, which application claims the benefit under 35 U.S.C. §119(e) of U.S. Provisional Patent Application No. 61/262,027, filed Nov. 17, 2009, the disclosure of which is hereby incorporated herein by reference.

### STATEMENT REGARDING FEDERALLY SPONSORED RESEARCH OR DEVELOPMENT

Not Applicable.

### BACKGROUND

1. Technical Field

The present invention relates to systems and methods for enhanced recovery and processing of heavy crude and/or bitumen. More particularly, the present invention relates to the high shear removal of asphaltenes from feeds comprising bitumen and/or heavy crude oil and the high shear separation of water and mineral solids from tailings conventionally sent to a tailings pond.

2. Background of the Invention

Large deposits of heavy hydrocarbon sometimes referred to as bitumen are located in many countries around the world. Bitumen may be recoverable by means of secondary or tertiary recovery processes that involve heating, solubilization or mobility control. Many of these heavy hydrocarbon deposits contain high concentrations of asphaltenes that contribute to difficulties in recovery, transporting and upgrading. Oil sands, also, known as tar sands, are heavy hydrocarbons found in the United States, Canada, Russia, Venezuela, and various countries in the Middle East. Deposits in the oil sands of Alberta Canada are the single-largest known source of petroleum in the world. These oil sands contain bitumen and as much as 17 wt % asphaltenes. The Orinoco oil belt in Venezuela is another large accumulation of bitumen. Additionally, heavy crudes produced all over the world typically contain some amount of asphaltenes.

Heavy crude oil or crude bitumen extracted from the earth is in a viscous, solid or semi-solid form that does not flow easily at normal oil pipeline temperatures, making it difficult to transport and expensive to process into gasoline, diesel fuel, and other products. The economic recovery and utilization of heavy hydrocarbons, including bitumen, is a significant energy challenge. The demand for heavy crudes, such as those extracted from oil sands, has increased significantly due to dwindling reserves of conventional lighter crude. These heavy hydrocarbons, however, are typically located in geographical regions far removed from existing refineries. Consequently, the heavy hydrocarbons are often transported via pipelines to refineries. In order to transport heavy crudes in pipelines they must meet pipeline quality specifications.

Extraction techniques utilized to recover bitumen may be broken down into three major categories: (1) those which employ water, either hot or cold, to float the bitumen oils away from the tar-sands, (2) those which employ an organic solvent to dissolve the bitumen oils, and (3) those that involve heat. Extraction of bitumen may be either by removing the deposits from the ground and extracting the bitumen externally or by in situ extraction, where only the bitumen is removed and the mineral components are left in the ground. Processes utilizing water often involve air floatation, and typically involve the utilization of an alkaline material. Due to the formation of stable emulsions containing fine tar-sands ore particles, water and bitumen oils, water-based processes are not particularly efficient, especially on ore of lower bitumen content. The treatment of emulsions comprising large volumes of water, bitumen oils and fine tar-sands ore particles has proven challenging.

Extraction of bitumen using heat can be done with electric, steam or other form of heaters as described, for example, in U.S. Pat. App. Nos. 2008/0135253 and 2009/0095480 by Vinegar et al. Various combinations of extraction techniques can be used to extract bitumen in situ. It is generally believed that in situ extraction will be more cost effective than surface mining, although the predominant method of bitumen extraction used today is surface mining. Another solvent extraction technique under development involves the utilization of solvents (in the absence of water) and is similar to techniques utilized in oil seed extraction processes. Percolation and immersion-type extractors have been used, but the need for special designs and scale-up for processing of abrasive tar-sands make economical extraction difficult. For example, the solvent to bitumen ratio needed for efficient extraction is generally high, up to 10:1, producing concomitantly high capital and utilities costs for recovery of the solvent via, for example, distillation. For economy of solvent utilization, spent sands must be stripped of residual solvent prior to disposal. Stripping of residual solvent is a capital and energy intensive undertaking.

Existing solvent extraction methods for dissolving bitumen oils from tar-sands, for example, as disclosed in U.S. Pat. No. 4,160,718 issued to Rendall, typically involve environmentally unacceptable losses of solvent and additional problems associated with the hazards posed by the necessary storage of large solvent inventories and the need for large quantities of water. Other solvent, hot water, and combination extraction processes are disclosed in U.S. Pat. Nos. 4,347,118 to Funk et al. and 3,925,189 to Wicks, III. These methods all have commercial and/or ecological drawbacks, rendering them undesirable. A method that utilizes both solvent and hot water for extraction of bitumen from tar-sands is the subject of U.S. Pat. No. 4,424,112 to Rendall.

Bitumen extraction techniques that do not involve solvent conventionally utilize truck and shovel operations. In such operations, the oil sand is first mined and then is delivered to a crusher. In one such process, bitumen separation and recovery from the oil sand is accomplished by following what is known as the Clark hot water extraction process. In the front end of this process, crushed oil sand is mixed with hot water and caustic in a rotating tumbler or conditioned in a pipeline to produce aqueous slurry. In the tumbler or pipeline, bitumen globules contact and coat air bubbles that are entrained in the slurry. The slurry is then screened to remove large rocks and the like. The screened slurry is diluted with additional water and the product is then temporarily retained in a primary separation vessel (PSV). In the PSV, the buoyant bitumen-coated air bubbles rise through the slurry and form bitumen froth. The sand in the slurry settles and is discharged from the base of the PSV, together with some water and bitumen. This stream or portion is referred to as the ‘PSV underflow’ or tailings. A ‘middlings’ portion comprising water, non-buoyant bitumen and fines may be collected from the middle of the PSV. The froth overflows the lip of the PSV and is recovered as the primary froth and typically comprises ˜60 wt. % bitumen, ˜30 wt. % water and ˜10 wt. % particulate solids.

The PSV underflow is introduced into a deep cone vessel, referred to as the tailings oil recovery vessel (‘TORV’). Here the PSV underflow is contacted and mixed with a stream of aerated middlings from the PSV. Again, bitumen and air bubbles contact and unite to form buoyant globules that rise and form froth. This ‘secondary’ froth overflows the lip of the TORV and is recovered. The secondary froth typically comprises ˜45 wt. % bitumen, ˜45 wt. % water and ˜10 wt. % solids. The middlings from the TORV is withdrawn and processed in a series of sub-aerated, impeller-agitated flotation cells. Secondary froth, typically comprising ˜40 wt. % bitumen, ˜50 wt. % water and ˜10 wt. % solids, is produced from these cells.

The primary and secondary froth streams are typically combined to yield a product froth stream, often comprising ˜60 wt. % bitumen, ˜32 wt. % water and ˜8 wt. % solids. The water and solids in the froth are contaminants which need to be reduced in concentration before the froth can be treated in a downstream refinery-type upgrading facility. This cleaning operation is generally carried out using what is referred to as ‘froth treatment.’

While there are a variety of froth treatment processes, all of these processes include deaeration of the combined froth product followed by dilution with sufficient solvent, typically naphtha, to provide a solvent to froth (‘S/F’) ratio of about 0.40 (w/w). This is done to increase the density differential between the diluted bitumen on the one hand and the water and solids on the other. By way of example, Kizior (U.S. Pat. No. 4,383,914), Guymon (U.S. Pat. No. 4,968,412), Shelfantook et al. (Canadian Pat. No. 1,293,465), Birkholz et al. (Canadian Pat. No. 2,232,929), Tipman et al. (Canadian Pat. No. 2,200,899), Tipman et al. (Canadian Pat. No. 2,353,109), Mishra et al. (U.S. Pat. No. 6,019,888), Cymerman et al. (U.S. Pat. No. 6,746,599), Beetge et al. (U.S. Pat. App. 20060196812, and Graham et al. (U.S. Pat. No. 5,143,598) describe ways of processing and treating the froth produced during the extraction process.

A serious problem, however, in using a solvent extraction process to remove bitumen from such a carbonaceous solid is that fines, primarily particles less than 50 microns in diameter, are carried over in the solvent-dissolved bitumen extract. Failure to remove the fines results in an undesirable high-ash bitumen product as well as problems with plugging of equipment used in the separation process, especially, for example, filtration equipment. Similar problems arise when other carbonaceous liquids besides bitumen, such as coal liquid or shale oil, are used. Removal of the fines during recovery of the bitumen from a carbonaceous solid or from a previously recovered carbonaceous liquid is therefore important in providing a desirable low-ash liquid product and minimizing fouling and plugging of equipment used in the process. It would be highly desirable to develop an extraction method for recovering bitumen from the aforesaid carbonaceous solids and for removing fines from the aforesaid carbonaceous liquids which would permit control of the solvency power of the extraction solvent so as to maximize the amount of bitumen or other carbonaceous liquid recovered and to minimize the fines content therein.

Following extraction of bitumen, a diluent such as light naphtha is often added for transportation. The naphtha must be distilled and recycled, adding to energy costs. Changes in temperature and/or composition may cause the asphaltenes to fall out of solution, necessitating pipeline cleaning. Typically, removal of asphaltenes desirably removes some of the heavy metals and sulfur associated with crude oil. It is well known that asphaltenes can be separated from bitumen or asphaltenic crude oil by precipitation with paraffinic solvents such as pentane or heptanes (see, for example, U.S. Pat. App. 2006/0260980 to Yeung; U.S. Pat. App. 2008/0245705 to Siskin et al.; U.S. Pat. No. 5,326,456 to Brons et al.; U.S. Pat. No. 5,316,659 et al.; U.S. Pat. No. 4,699,709 to Peck et al.; and U.S. Pat. No. 4,596,651 to Wolff et al.). Additionally, various settling aids and/or flocculants have been utilized to enhance separation of asphaltenes (see, for example, U.S. Pat. App. 2006/0196812 to Beetge et al.).

It is conventionally believed that a high solvent to oil ratio (e.g., on the order of 40:1 by volume) is required to separate substantially-pure asphaltenes from bitumen or asphaltic crude oil. At lower solvent levels, commonly used in solvent deasphalting, substantial non-asphaltenic material precipitates with the asphaltenes, resulting in undesirable oil losses. Furthermore, solvent deasphalting relies on multiple theoretical stages of separation of barely immiscible hydrocarbon liquids, such stages are intolerant to the presence of water. The oil yield of solvent deasphalting is also limited by the high viscosity of the resultant asphaltic materials, particularly for high viscosity bitumen feeds. It is thus difficult to obtain high quality oil with high oil yield due to the difficulties in achieving clean separation of the oil and asphaltic fractions. In solvent deasphalting, asphalt (essentially asphaltenes with residual oil) is produced as a very viscous hot liquid, which forms glassy solids when cooled. This viscous liquid must be heated to a high temperature in order to be transportable, causing fouling and plugging limitations.

Another technique for removal of asphaltenes involves breaking a froth of extra heavy oil and water with heat and a diluent solvent such as naphtha. In the case of paraffinic naphtha, partial asphaltene removal results. However, only about 50% of the asphaltenes may be readily removed with this treatment even with multiple stages and complete removal of asphaltenes is thus not practical. As a result, the resulting oils must still be processed by capital intensive technology that is relatively tolerant to asphaltenes.

Despite the development of the above mentioned froth and solvent extraction processes, there remains a need for improved systems and processes of extracting bitumen of higher quality, for example, containing less water, less solids, less asphaltenes and/or less diluent. It would be desirable if the enhanced systems and processes would allow increased bitumen recovery, for example, by reducing oil losses during asphaltene removal and/or reduced oil losses in the tailings. There is also a need in the art for a method of selectively and efficiently removing asphaltenic contaminants from heavy oil, which mitigates the above-mentioned difficulties of the prior art. It would be even further desirable if the systems and processes would allow bitumen extraction and/or asphaltene removal without requiring high solvent and/or water-to-bitumen ratios, long residence times or numerous or expensive processing units. Such systems and processes should desirably facilitate recycle and thus economy of utilization of process water and/or conditioning agents, such as base (e.g., caustic) and/or bicarbonate.

### SUMMARY

Herein disclosed is a method of removing at least one component from a feed comprising tailings, asphaltenic oil or a combination thereof, the method comprising: subjecting the feed to high shear in the presence of carbon dioxide to produce a high shear-treated product; and separating the at least one component from the high shear-treated product to produce a component-reduced product. Subjecting the feed to high shear in the presence of carbon dioxide may further comprise subjecting the feed to a shear rate of at least 10,000 s⁻¹. In embodiments, subjecting the feed to high shear in the presence of carbon dioxide comprises a shear rate of at least 20,000 s⁻¹. In embodiments, subjecting the feed to high shear comprises introducing the feed and carbon dioxide into a high shear device comprising at least one rotor and at least one complementarily-shaped stator. High shear may comprise a shear rate of at least 10,000 s⁻¹, wherein the shear rate is defined as the tip speed divided by the shear gap, and wherein the tip speed is defined as πDn, where D is the diameter of the at least one rotor and n is the frequency of revolution. In embodiments, high shear comprises a shear rate of at least 20,000 s⁻¹. In embodiments, subjecting the feed to a shear rate of at least 10,000 s⁻¹ produces a local pressure of at least about 1034.2 MPa (150,000 psi) at a tip of the at least one rotor. In embodiments, subjecting the feed to high shear comprises providing a tip speed of the at least one rotor of at least about 23 msec, wherein the tip speed is defined as πDn, where D is the diameter of the at least one rotor and n is the frequency of revolution.

In embodiments, the high shear-treated product comprises a dispersion of carbon dioxide bubbles. The carbon dioxide bubbles may have an average bubble diameter of less than about 1 micron. In embodiments, the carbon dioxide bubbles have an average bubble diameter of less than about 0.5 micron.

In embodiments, the feed comprises tailings from a caustic bitumen extraction process and the component-reduced product comprises water having less than 10 wt % impurities. The method may further comprise recycling at least a portion of the water to the bitumen extraction process. Separating the at least one component may comprise separating solids from the high shear-treated product to produce a solids-reduced product and separating an oil phase from the solids-reduced product to produce the component-reduced product, wherein the component-reduced product comprises water. In embodiments, the tailings are obtained from a tailings pond of a bitumen extraction process. In embodiments, at least a portion of the tailings are produced by: mixing tar sand and water in a tumbler or a hydrotransport line to form a froth; introducing the froth into a separation cell; and removing the at least a portion of the tailings from the separation cell. In embodiments, at least a portion of the tailings are produced by introducing a middlings portion from a separation cell of a bitumen extraction process into a secondary separation unit and extracting the at least a portion of the tailings from the secondary separation cell.

In embodiments, at least a portion of the tailings are produced by introducing a bitumen froth from a separation cell of a bitumen extraction process into one or more centrifuge and extracting the at least a portion of the tailings from the one or more centrifuge. In embodiments, subjecting the feed comprising tailings to high shear in the presence of carbon dioxide reduces the pH to less than about 6. In embodiments, subjecting the feed to high shear converts the caustic in the tailings to sodium bicarbonate, enhancing the rate of separation of water from the tailings relative to conventional tailings treatment processes.

In embodiments, the feed comprises asphaltenic oil, the at least one product comprises asphaltenes and the component-reduced product comprises asphaltene-reduced oil. The asphaltenic oil may be selected from the group consisting of bitumen comprising at least some percentage of asphaltenes, heavy crude oil comprising at least some percentage of asphaltenes, and combinations thereof. Separating the at least one component from the high shear-treated product to produce a component-reduced product may comprise introducing the high shear-treated product into a centrifuge operated to separate asphaltenes from asphaltene-reduced product oil.

In embodiments, the asphaltenic oil feed is subjected to high shear in the presence of water. In embodiments, the feed has an API gravity of less than about 10 and the asphaltene-reduced product oil has an API gravity of greater than about 10. In embodiments, the asphaltene-reduced product oil comprises at least about 90 wt % bitumen. In embodiments, the asphaltene-reduced product oil comprises less than about 10 wt % asphaltenes. In embodiments, the asphaltene-reduced product oil comprises less than about 5 wt % water, less than about 1 wt % solids, or both.

Also disclosed herein is a method of removing asphaltenes from asphaltenic oil, the method comprising: subjecting the asphaltenic oil to a shear rate of at least 10,000 s⁻¹ in the presence of carbon dioxide to produce a high shear-treated product; and separating asphaltenes from the high shear-treated product to produce an asphaltene-reduced product oil. In embodiments, the asphaltenic oil is selected from bitumen and heavy crude oils. The method may further comprise separating carbon dioxide from the high shear-treated product and recycling the separated carbon dioxide to the subjecting step. In embodiments, the asphaltene-reduced oil product comprises less than about 10 wt % asphaltenes.

Also disclosed, is an improvement in an aqueous bitumen extraction process comprising forming a bitumen froth by tumbling tar sand with water and base in a tumbler or hydrotransporting tar sand with water and base in a transport pipeline; and separating the bitumen froth from tailings in a separation cell; the improvement comprising: subjecting the tailings to high shear in the presence of carbon dioxide to produce a high shear-treated product; separating solids from the high shear treated product to produce a solids-reduce product; separating water from the solids-reduced product; and recycling the water to the froth forming step. The water may comprise less than about 10, 5, 3, or 1 wt % impurities. Separating solids from the high shear treated product to produce a solids-reduce product may be performed with at least one centrifuge. Separating water from the solids-reduced product may be performed with at least one settling tank. In embodiments, an oil phase is removed from an upper portion of the settling tank and the water from a lower portion of the settling tank. In embodiments, subjecting the tailings to high shear in the presence of carbon dioxide produces a high shear-treated product having a pH of less than about 6.

Also disclosed is a system for removing at least one component from a feed comprising tailings, asphaltenic oil or a combination thereof, the system comprising: at least one high shear device comprising at least one rotor and at least one complementarily-shaped stator and configured to subject the feed to high shear in the presence of carbon dioxide and produce a high shear-treated product, wherein the at least one high shear device is configured to subject the contents therein to a shear rate of at least 10,000 s⁻¹, wherein the shear rate is defined as the tip speed divided by the shear gap, and wherein the tip speed is defined as πDn, where D is the diameter of the at least one rotor and n is the frequency of revolution; and at least one separation unit configured to separate a component from the high shear-treated product, providing a component-reduced product. In embodiments, the at least one rotor is configured to provide a tip speed of at least about 23 msec. In embodiments, the at least one rotor is configured to provide a tip speed of at least about 40 msec. In embodiments, the at least one rotor is separated from the at least one stator by a shear gap of less than about 5 μm, wherein the shear gap is the minimum distance between the at least one rotor and the at least one stator.

In embodiments, the feed comprises tailings from a bitumen extraction process, the at least one component comprises solids and oil and the system comprises a first separation unit configured to separate solids from the high shear-treated product producing a solids-reduced product and a second separation unit configured to separate oil from the solids-reduced product providing substantially pure water as component-reduced product. The system may further comprise a tailings pond from which the feed is obtained. In embodiments, the first separation unit is a centrifuge and the second separation unit is a settling tank. In embodiments, the feed comprises asphaltenic oil, the at least one component comprises asphaltenes, and the component-reduced product comprises asphaltene-reduced oil. The feed may have an API gravity of less than 10 and the asphaltene-reduced product may have an API gravity of greater than 10. In embodiments, the asphaltene-reduced oil comprises less than about 10 wt % asphaltenes. In embodiments, the asphaltene-reduced oil further comprises less than about 5 wt % solids, less than 5 wt % water or both.

Also disclosed is a method of removing at least one component from a feed stream comprising tar sands tailings, asphaltenic oil, or a combination thereof, that may include the steps of subjecting the feed stream to high shear separation in a high shear device to produce a high shear-treated product stream; and substantially separating the at least one component from the high shear-treated product stream to produce a component-reduced product stream. In embodiments, the feed stream may be liquid phase, the feed may have the at least one component suspended therein, and/or wherein the high shear device may operate to subject the feed to a shear rate of at least 20,000 s⁻¹. The tar sands tailings may result from a caustic bitumen extraction process, and wherein the component-reduced product may have water therein having less than 10 wt % impurities. The component-reduced product stream may include asphaltene-reduced oil.

In some aspects, the feed stream may be substantially liquid phase, wherein subjecting the feed stream to high shear may include introducing the feed stream to a high shear device that may be configured with at least one rotor and at least one complementarily-shaped stator.

The step of substantially separating the at least one component may further include separating solids from the high shear-treated product to produce a solids-reduced product and separating an oil phase from the solids-reduced product to produce the component-reduced product, wherein the component-reduced product comprises water. The step of substantially separating the at least one component from the high shear-treated product to produce a component-reduced product may further include introducing the high shear-treated product into a centrifuge operated to separate asphaltenes from asphaltene-reduced product oil. In an embodiment, the asphaltene-reduced product oil may include less than about 5 wt % water, less than about 1 wt % solids, or both.

Yet other embodiments of the disclosure include in an aqueous bitumen extraction process comprising treating a bitumen froth, the process improvement including subjecting the bitumen froth to high shear in a substantially gas-free environment to produce a high shear treated product; separating solids from the high shear treated product to produce a solids-reduced product; separating water from the solids-reduced product; and recycling the water to the high shear step.

Yet other embodiments disclosed include a system for removing at least one component from a feed stream comprising tar sand tailings, asphaltenic oil, or a combination thereof, the system including at least one high shear device comprising at least one rotor and at least one complementarily-shaped stator and configured to subject the feed stream to high shear and produce a high shear-treated product, wherein the at least one high shear device is configured to subject the contents therein to a shear rate of at least 10,000 s⁻¹; and at least one separation unit configured to separate a component from the high shear-treated product, providing a component-reduced product.

The feed stream may include tar sand tailings produced from a bitumen extraction process. The at least one component may include solids and oil. The system may also include a first separation unit configured to separate solids from the high shear-treated product producing a solids-reduced product and a second separation unit configured to separate oil from the solids-reduced product providing substantially pure water as component-reduced product.

In accordance with other embodiments disclosed, a method for removing contaminants from feedwater may include the steps of subjecting the feedwater to high shear separation in a high shear device to produce a high shear-treated product; and using a separator to remove at least some contaminants from the high shear-treated product to produce a contaminant-reduced product. feedwater may include waste water, surface water, groundwater, or a combination thereof.

In still yet other embodiments, a system for treating feedwater to remove contaminants therefrom, the system including at least one high shear mixing device comprising at least one generator comprising a rotor and a stator separated by a shear gap, wherein the shear gap is the minimum distance between the rotor and the stator, and wherein the high shear mixing device is capable of producing a tip speed of the rotor of greater than 22.9 m/s (4,500 ft/min); and a pump configured for delivering feedwater to the high shear mixing device.

The system may include a tank from which treated water is extracted, an inlet of the tank fluidly connected to the outlet of the high shear device. The high shear device may include at least two generators. In an embodiment, the shear rate provided by one generator may be greater than the shear rate provided by another generator.

According to embodiments of this disclosure, a high shear device is used to improve the recovery and processing of heavy crude bitumen. In one aspect of the present invention a high shear device is used in combination with reactive gas (e.g. carbon dioxide) to enhance the separation of clay and other inorganic mineral solids from the bitumen once it is extracted from the ground. In another aspect of the present invention a high shear device is used in combination with carbon dioxide to enhance the separation of asphaltenes and other undesirable elements of bitumen following removal of inorganic contaminants, thus allowing for easier transportation and downstream processing of the recovered bitumen.

Certain embodiments of the above-described methods or systems potentially provide overall cost reduction by reducing the size and/or number of downstream purification apparatus/steps, providing oil having reduced levels of impurities including, but not limited to, asphaltenes, sand, silt, solids, sulfur and/or other heavy metals, and/or water, permitting operation at low temperature and/or pressure relative to conventional heavy crude oil or bitumen processing, and/or reducing capital and/or operating costs of bitumen extraction or heavy crude oil processing. These and other embodiments and potential advantages will be apparent in the following detailed description and drawings.

### BRIEF DESCRIPTION OF THE DRAWINGS

For a more detailed description of the preferred embodiment of the present invention, reference will now be made to the accompanying drawings, wherein:

FIG. 1 is a schematic of a high shear system comprising an external high shear mixer/disperser according to an embodiment of the present disclosure.

FIG. 2 is a schematic of a high shear system comprising an external high shear mixer/disperser according to another embodiment of the present disclosure.

FIG. 3 is a schematic flow diagram of a prior art hot water extraction process suitable for incorporation, as indicated, for example, by arrows A and B, of one or more high shear devices according to this disclosure.

FIG. 4 is a longitudinal cross-section view of a high shear mixing device suitable for use in embodiments of the disclosed system.

FIG. 5 is a box flow diagram of a method of removing a component from a stream produced in heavy oil or bitumen recovery and/or processing.

### NOTATION AND NOMENCLATURE

As used herein, the phrase ‘asphaltenic oil’ refers to any oil containing at least some percentage of asphaltenes. The ‘asphaltenic oil’ may be, for example, bitumen comprising asphaltenes, heavy crude oil comprising asphaltenes, and the like.

As used herein, the term ‘dispersion’ refers to a liquefied mixture that contains at least two distinguishable substances (or ‘phases’). As used herein, a ‘dispersion’ comprises a ‘continuous’ phase (or ‘matrix’), which holds therein discontinuous droplets, bubbles, and/or particles of the other phase or substance. The term dispersion may thus refer to foams comprising gas bubbles suspended in a liquid continuous phase, emulsions in which droplets of a first liquid are dispersed throughout a continuous phase comprising a second liquid with which the first liquid is immiscible, and continuous liquid phases throughout which solid particles are distributed. As used herein, the term “dispersion” encompasses continuous liquid phases throughout which gas bubbles are distributed, continuous liquid phases throughout which solid particles are distributed, continuous phases of a first liquid throughout which droplets of a second liquid that is substantially insoluble in the continuous phase are distributed, and liquid phases throughout which any one or a combination of solid particles, immiscible liquid droplets, and gas bubbles is distributed. Hence, a dispersion can exist as a homogeneous mixture in some cases (e.g., liquid/liquid phase), or as a heterogeneous mixture (e.g., gas/liquid, solid/liquid, or gas/solid/liquid), depending on the nature of the materials selected for combination. A dispersion may comprise, for example, bubbles of gas (e.g. carbon dioxide) in a liquid (e.g. stream comprising tailings, bitumen and/or heavy crude oil) and/or droplets of one fluid in a phase with which it is immiscible.

Use of the phrase, ‘all or a portion of’ is used herein to mean ‘all or a percentage of the whole’ or ‘all or some components of’.

### DETAILED DESCRIPTION

Overview.

Herein disclosed are systems and methods of removing a component from a stream produced during recovery and/or processing of heavy crude oil or bitumen (e.g. from tar sands). The system and method are utilized, in embodiments, to precipitate asphaltenes from bitumen or heavy crude oil. In embodiments, the system and method are suitable for facilitating recovery of water from slurries (comprising sediments/sand particles) that are conventionally introduced into tailings ponds or recycled back to the process. The system comprises an external high shear mechanical device to provide rapid contact and mixing of reactants in a controlled environment in the reactor/mixer device. In embodiments, the system and method allow removal of asphaltenes at lower temperatures and/or pressures than conventional methods or more rapid and complete removal of asphaltenes. In embodiments, the system and method allow extraction of bitumen from tar sands with utilization of less water by facilitating removal of water from a stream produced during extraction and recycle of removed water for further extraction. A reactor assembly that comprises an external high shear device (HSD) or mixer as described herein may decrease mass transfer limitations and thereby allow faster precipitation and/or removal of a desired component, such as precipitation and removal of asphaltenes from oil, removal of solids from tailings, and removal of water from tailings.

System for Removal of a Component from a Stream Produced During Recovery and/or Processing of Heavy Crude Oil or Bitumen.

Herein disclosed is a system for removal of a component from a stream produced during recovery and/or processing of heavy crude oil or bitumen. In embodiments, the system is utilized for removal of asphaltenes from asphaltenic heavy crude oil or bitumen. In embodiments, the system is utilized to enhance extraction of bitumen from tar sand and reduce water usage during extraction.

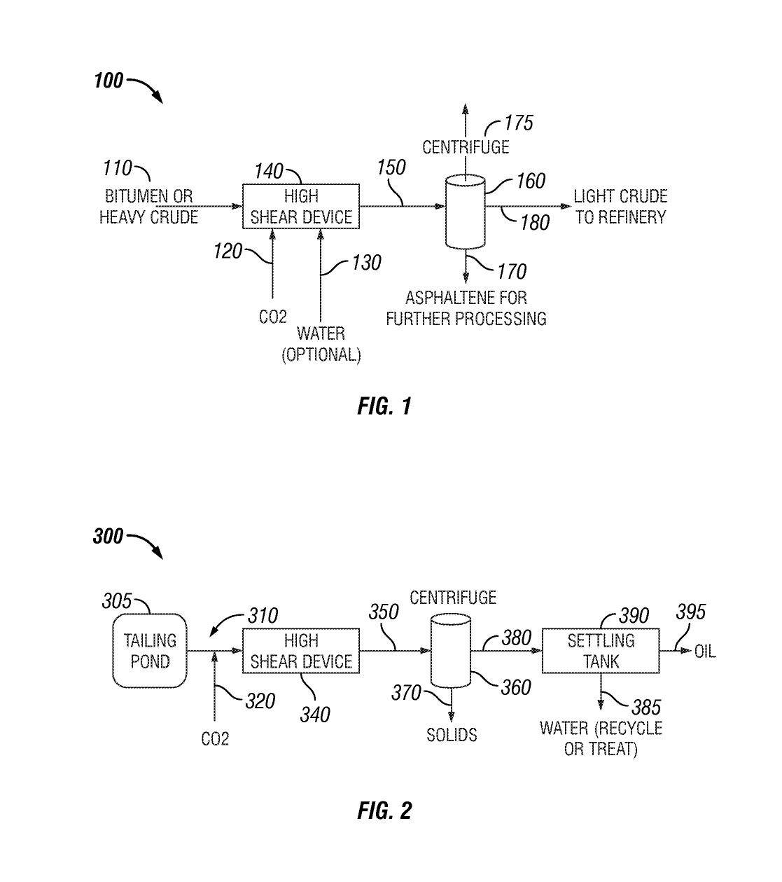

FIG. 1 is a schematic of a high shear system 100 according to an embodiment of this disclosure. System 100 comprises high shear device 140 and centrifuge 160. Although described herein as a centrifuge, it is to be understood that unit 160 may be any gravity metric separation device known to those experienced in the art can also be used. FIG. 2 is a schematic of a high shear system 300 according to another embodiment of this disclosure. High shear system 300 comprises a source 305 of material conventionally introduced into a tailings pond and a settling tank 390 in addition to high shear device 340 and centrifuge 360. Optionally the bitumen/water mix may be introduced directly to the high shear device from a tumbler extraction unit where the bitumen is initially separated from the sand. Each of these components of high shear systems 100/300 is described in more detail hereinbelow. One or more lines are connected to the HSD for introducing feed mixture thereto. As pure bitumen is rather thick and not readily pump-able diluents might be added at any stage. Additionally, in order to avoid having to dilute the bitumen, following separation of the sand, the extracted water/bitumen mix (dilute bitumen) can be subjected to CO₂ and shear and the asphaltene dropped out, in embodiments. The CO₂ bitumen/water mix may be heated as necessary following the shear.

In the embodiment of FIG. 1, lines 110, 120 and 130 are fluidly connected with HSD 140 for the introduction of feed comprising bitumen, heavy crude or streams conventionally sent to a tailings pond; reactant gas (e.g. carbon dioxide); and (optionally) water, respectively. In alternative embodiments, a single inlet line is fluidly connected with the HSD and the feed (e.g., tailings, bitumen, water and/or heavy crude oil), reactant gas (e.g. carbon dioxide), and optionally additional water are combined prior to introduction into the HSD. For example, in the embodiment of FIG. 2, tailings from source 305 (e.g. a tailings pond) is combined in line 310 with reactant gas (e.g. carbon dioxide) in line 320 prior to introduction into HSD 340. Water, either heated or at ambient conditions can be added at any point in the process to aid in flow to aid in the formation of carbonic acid and/or to aid in the separation of unwanted elements from the product oil (e.g. bitumen).

In addition to carbon dioxide, various other compounds can be reacted with the asphaltenes to cause them to separate out including SO₃, NO₂, and P₂O₅ as described in US Patent App. No. 2008/0251418. In the case of reaction with SO₃, the asphaltene can be dimerized. Although description is made primarily with respect to utilization of carbon dioxide as reactant, it is to be understood that other reactions that destabilize asphaltenes can also be accelerated via the herein-disclosed utilization of high shear. For example, air or O₂ may also be introduced to aid in separation and/or to aid in BOD/COD (biological oxygen demand, chemical oxygen demand) reductions of the water.

Water, either heated or at ambient conditions can be added at any point in the process to aid in flow, formation of carbonic acid and aid in the separation of unwanted elements from the bitumen.

Flow line 150/350 carries a high shear-treated stream out of HSD 140. Flow line 150/350 is any line into which the high shear-treated stream from HSD 140/340 (comprising a dispersion of reactant gas in feed) flows. One or more dispersible gas lines 120/320 are configured to introduce gas into HSD 140/340. The reactant gas may be selected from carbon-dioxide-containing gas streams, or may be substantially pure carbon dioxide, in certain applications. In embodiments, the reactant is any reactant known to result in aromatic substitution, for example, as per U.S. Patent App. No. 2008/0251418, which is hereby incorporated herein for all purposes not contrary to this disclosure. Line(s) 120/320 may introduce reactant gas into HSD 140/340 directly or may introduce reactant gas into the HSD via line 110/310.

Centrifuge 160/360 is fluidly connected to HSD 140/340 via high shear-treated product flow line 150/350. Centrifuge 160/360 may comprise one or more outlet lines. For example, in the embodiment of FIG. 1, centrifuge 160 comprises heavy component outlet line 170 and component-reduced (e.g., asphaltene-reduced) product outlet line 180. A gas outlet line 175 may be fluidly connected with the centrifuge for removal of reactant or product gas. A recycle line may fluidly connect the gas outlet line with reactant gas inlet line 120/320, for recycle of reactant gas to HSD 140/340. In the embodiment of FIG. 2, centrifuge 360 comprises a heavy component outlet line 370 and a component-reduced (e.g., solids-reduced) product outlet line 380.

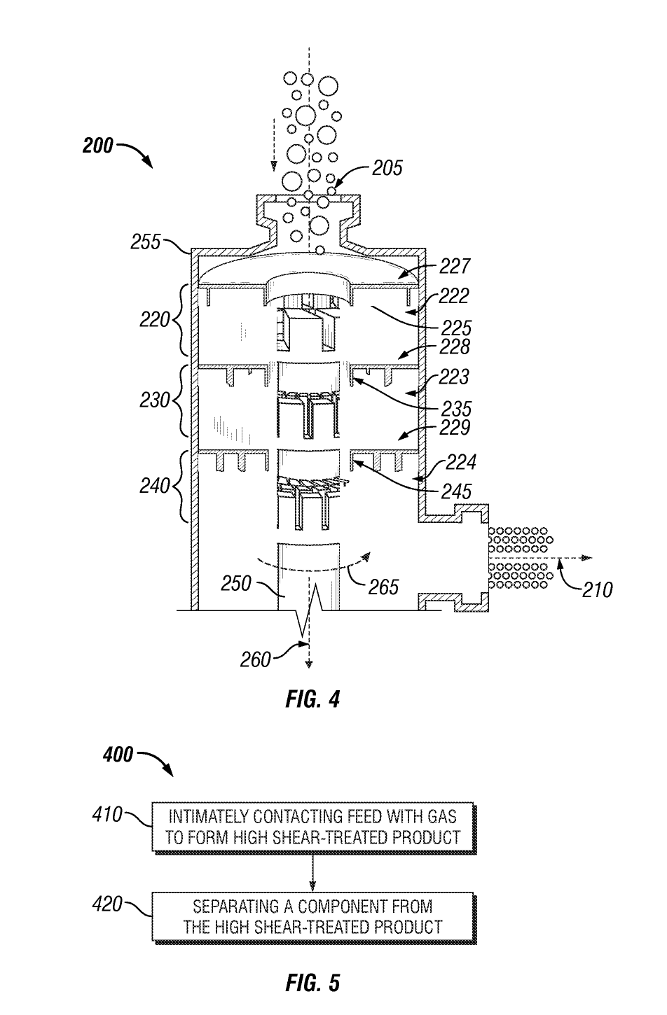

As mentioned hereinabove, the high shear system may further comprise a feed source. For example, bitumen or heavy crude for introduction into HSD 140 via line 110 may be produced using apparatus known in the art and discussed further hereinbelow with respect to FIG. 4. Feed introduced into HSD 340 via feed line 310 may comprise tailings conventionally introduced into a tailings pond or recycled. The tailings may be produced using any means known in the art, and high shear system 340 may comprise apparatus for the production of such tailings. In instances, system 300 may further comprise feed source 305 which may comprise, for example, a tailings pond. In other embodiments, the tailings are produced utilizing any combination of the apparatus disclosed in U.S. Pat. No. 5,626,743. In embodiments, the disclosed system obviates the need for a conventional tailings pond, and the use of the term tailings is meant to indicate those streams conventionally introduced into a tailings pond but does not require that the tailings come from a tailings pond, per se.

The high shear system may also comprise downstream processing apparatus. For example, high shear system 340 may further comprise separation apparatus 390 adapted for separation of a water phase from an oil phase. Separation apparatus 390 may comprise a settling tank. Component-reduced product outlet line 380 fluidly connects centrifuge 360 with separation apparatus 390. Separation apparatus 390 is configured to provide adequate residence time for separation of an oil phase comprising oil (e.g. bitumen) from an aqueous phase. The aqueous phase may comprise bicarbonate.

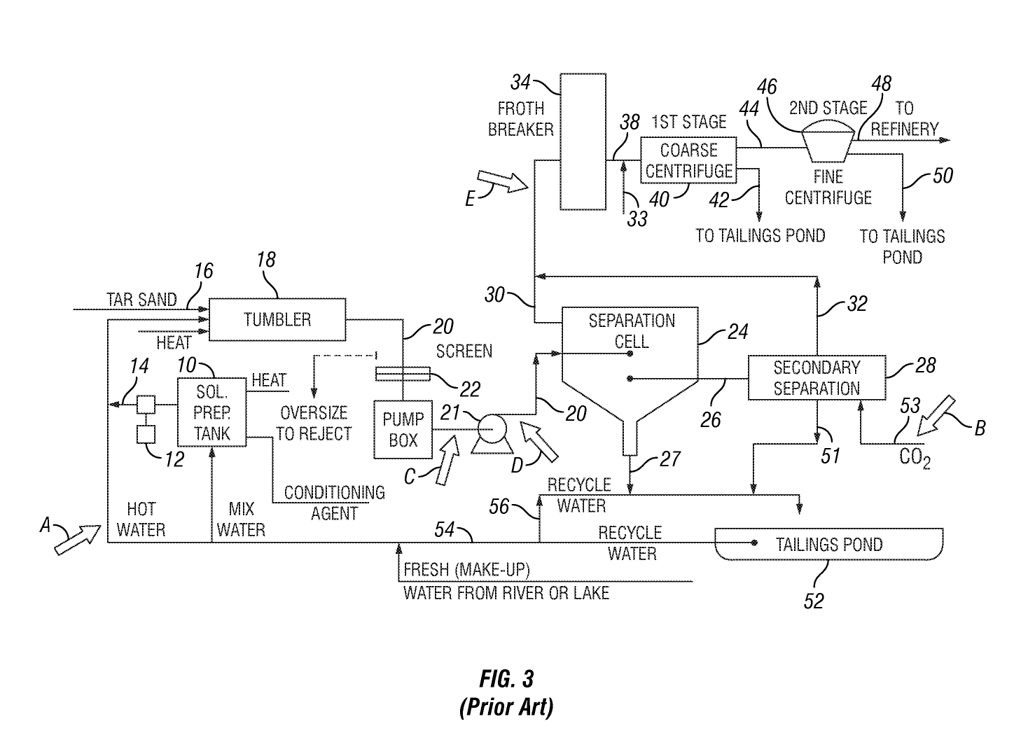

A recycle line may fluidly connect separation apparatus 390 with a system for water extraction of bitumen from tar sands, such that the recovered water from separation apparatus 390 may be recycled for further extraction. Suitable systems for extraction of bitumen from tar sands include hot water extraction systems, for example, as disclosed in U.S. Pat. No. 5,626,743. FIG. 3 is a prior art system for hot water extraction of bitumen from tar sands, as described in U.S. Pat. No. 5,626,743. High shear system 100/300 may be incorporated into an existing system for extraction of bitumen from tar sands or may be incorporated into a system for the processing of heavy crude oil. In embodiments, high shear system 100/300 further comprises a combination of the apparatus indicated in FIG. 4, whereby the feed to HSD 140/340 is obtained. Thus, in embodiments, high shear system 100/300 further comprises one or more tumblers 18, one or more transport pipes adapted for hydrotransport of feed whereby a bitumen froth is formed, one or more separation cells 24, one or more tailings ponds 52, one or more secondary separation units 28, or some combination thereof.

Additional components or process steps can be incorporated between HSD 140/340 and centrifuge 160/360 or ahead of HSD 140/340, if desired, as will become apparent upon reading the description of the high shear process hereinbelow.

High Shear Device 140.

The high shear system comprises at least one high shear device 140/340. External high shear device (HSD) 140/340, also sometimes referred to as a high shear mixer, is configured for receiving a feed stream, via line 110/310. As mentioned above, HSD 140/340 may comprise one or more additional inlet lines 120, 130 for introduction of reactant gas or water, respectively. One or more line(s) 120 may be configured to introduce reactant gas into HSD 140. The HSD may be configured for receiving feed mixture and reactant gas via separate inlet lines 110 and 120, respectively, or the feed and reactant gas may be combined prior to introduction into the HSD. Although only one HSD is shown for contacting reactant gas and feed mixture in the embodiments of FIGS. 1 and 2, it should be understood that some embodiments of the system can comprise two or more HSDs for contacting feed and reactant gas. The two or more HSDs can be arranged in either series or parallel flow. In embodiments, high shear system 100/300 comprises a single HSD.

HSD 140/340 is a mechanical device that utilizes one or more generators comprising a rotor/stator combination, each of which has a gap between the stator and rotor. The gap between the rotor and the stator in each generator set may be fixed or may be adjustable. HSD 140/340 is configured in such a way that it is capable of effectively contacting the components therein at rotational velocity. The HSD comprises an enclosure or housing so that the pressure and temperature of the fluid therein may be controlled.

High shear mixing devices are generally divided into three general classes, based upon their ability to mix fluids. Mixing is the process of reducing the size of particles or inhomogeneous species within the fluid. One metric for the degree or thoroughness of mixing is the energy density per unit volume that the mixing device generates to disrupt the fluid particles. The classes are distinguished based on delivered energy densities. Three classes of industrial mixers having sufficient energy density to consistently produce mixtures or emulsions with particle sizes in the range of submicron to 50 microns include homogenization valve systems, colloid mills and high speed mixers. In the first class of high energy devices, referred to as homogenization valve systems, fluid to be processed is pumped under very high pressure through a narrow-gap valve into a lower pressure environment. The pressure gradients across the valve and the resulting turbulence and cavitation act to break-up any particles in the fluid. These valve systems are most commonly used in milk homogenization and can yield average particle sizes in the submicron to about 1 micron range.

At the opposite end of the energy density spectrum is the third class of devices referred to as low energy devices. These systems usually have paddles or fluid rotors that turn at high speed in a reservoir of fluid to be processed, which in many of the more common applications is a food product. These low energy systems are customarily used when average particle sizes of greater than 20 microns are acceptable in the processed fluid.

Between the low energy devices and homogenization valve systems, in terms of the mixing energy density delivered to the fluid, are colloid mills and other high speed rotor-stator devices, which are classified as intermediate energy devices. A typical colloid mill configuration includes a conical or disk rotor that is separated from a complementary, liquid-cooled stator by a closely-controlled rotor-stator gap, which is commonly between 0.025 mm to 10 mm (0.001-0.40 inch). Rotors are usually driven by an electric motor through a direct drive or belt mechanism. As the rotor rotates at high rates, it pumps fluid between the outer surface of the rotor and the inner surface of the stator, and shear forces generated in the gap process the fluid. Many colloid mills with proper adjustment achieve average particle sizes of 0.1 to 25 microns in the processed fluid. These capabilities render colloid mills appropriate for a variety of applications including colloid and oil/water-based emulsion processing such as that required for cosmetics, mayonnaise, or silicone/silver amalgam formation, to roofing-tar mixing.

The HSD comprises at least one revolving element that creates the mechanical force applied to the reactants therein. The HSD comprises at least one stator and at least one rotor separated by a clearance. For example, the rotors can be conical or disk shaped and can be separated from a complementarily-shaped stator. In embodiments, both the rotor and stator comprise a plurality of circumferentially-spaced rings having complementarily-shaped tips. A ring may comprise a solitary surface or tip encircling the rotor or the stator. In embodiments, both the rotor and stator comprise more than 2 circumferentially-spaced rings, more than 3 rings, or more than 4 rings. For example, in embodiments, each of three generators comprises a rotor and stator each having 3 complementary rings, whereby the material processed passes through 9 shear gaps or stages upon traversing the HSD. Alternatively, each of three generators may comprise four rings, whereby the processed material passes through 12 shear gaps or stages upon passing through the HSD. In some embodiments, the stator(s) are adjustable to obtain the desired shear gap between the rotor and the stator of each generator (rotor/stator set). Each generator may be driven by any suitable drive system configured for providing the desired rotation.

In some embodiments, the HSD comprises a single stage dispersing chamber (i.e., a single rotor/stator combination; a single high shear generator). In some embodiments, HSD 140/340 is a multiple stage inline disperser and comprises a plurality of generators. In certain embodiments, the HSD comprises at least two generators. In other embodiments, HSD 140/340 comprises at least 3 generators. In some embodiments, HSD 140/340 is a multistage mixer whereby the shear rate (which varies proportionately with tip speed and inversely with rotor/stator gap width) varies with longitudinal position along the flow pathway, as further described hereinbelow.

According to this disclosure, at least one surface within HSD 140/340 may be made of, impregnated with, or coated with a catalyst that is suitable for assisting the desired component extraction, for example converting caustic soda to sodium bicarbonate. Further description is provided in U.S. patent application Ser. No. 12/476,415, which is hereby incorporated herein by reference for all purposes not contrary to this disclosure.

In some embodiments, the minimum clearance (shear gap width) between the stator and the rotor is in the range of from about 0.025 mm (0.001 inch) to about 3 mm (0.125 inch). The shear gap may be in the range of from about 5 micrometers (0.0002 inch) and about 4 mm (0.016 inch). In embodiments, the shear gap is in the range of 5, 4, 3, 2 or 1 μm. In some embodiments, the minimum clearance (shear gap width) between the stator and the rotor is in the range of from about 1 (0.00004 inch) to about 3 mm (0.012 inch). In some embodiments, the minimum clearance (shear gap width) between the stator and the rotor is less than about 10 μm (0.0004 inch), less than about 50 μm (0.002 inch), less than about 100 μm (0.004 inch), less than about 200 μm (0.008 inch), less than about 400 μm (0.016 inch). In certain embodiments, the minimum clearance (shear gap width) between the stator and rotor is about 1.5 mm (0.06 inch). In certain embodiments, the minimum clearance (shear gap width) between the stator and rotor is about 0.2 mm (0.008 inch). In certain configurations, the minimum clearance (shear gap) between the rotor and stator is at least 1.7 mm (0.07 inch). The shear rate produced by the HSD may vary with longitudinal position along the flow pathway. In some embodiments, the rotor is set to rotate at a speed commensurate with the diameter of the rotor and the desired tip speed. In some embodiments, the HSD has a fixed clearance (shear gap width) between the stator and rotor. Alternatively, the HSD has adjustable clearance (shear gap width).

Tip speed is the circumferential distance traveled by the tip of the rotor per unit of time. Tip speed is thus a function of the rotor diameter and the rotational frequency. Tip speed (in meters per minute, for example) may be calculated by multiplying the circumferential distance transcribed by the rotor tip, 2πR, where R is the radius of the rotor (meters, for example) times the frequency of revolution (for example revolutions per minute, rpm). The frequency of revolution may be greater than 250 rpm, greater than 500 rpm, greater than 1000 rpm, greater than 5000 rpm, greater than 7500 rpm, greater than 10,000 rpm, greater than 13,000 rpm, or greater than 15,000 rpm. The rotational frequency, flow rate, and temperature may be adjusted to get a desired product profile. If channeling should occur, and reaction is inadequate, the rotational frequency may be increased to minimize undesirable channeling. Alternatively or additionally, high shear-treated product may be introduced into a second or subsequent HSD.

HSD 140/340 may provide a tip speed in excess of 22.9 m/s (4500 ft/min) and may exceed 40 m/s (7900 ft/min), 50 m/s (9800 ft/min), 100 m/s (19,600 ft/min), 150 m/s (29,500 ft/min), 200 m/s (39,300 ft/min), or even 225 m/s (44,300 ft/min) or greater in certain applications. For the purpose of this disclosure, the term ‘high shear’ refers to mechanical rotor stator devices (e.g., colloid mills or rotor-stator dispersers) that are capable of tip speeds in excess of 5.1 m/s (1000 ft/min) or those values provided above and require an external mechanically driven power device to drive energy into the stream of products to be reacted. By contacting the reactants with the rotating members, which can be made from, coated with, or impregnated with stationary catalyst, significant energy is transferred to the reaction. The energy consumption of the HSD 140/340 will generally be very low.

In some embodiments, HSD 140/340 is capable of delivering at least 300 L/h at a tip speed of at least 22.9 m/s (4500 ft/min) The power consumption may be about 1.5 kW. HSD 140/340 combines high tip speed with a very small shear gap to produce significant shear on the material being processed. The amount of shear will be dependent on the viscosity of the fluid in the HSD. Accordingly, a local region of elevated pressure and temperature is created at the tip of the rotor during operation of HSD 140/340. In some cases the locally elevated pressure is about 1034.2 MPa (150,000 psi). In some cases the locally elevated temperature is about 500° C. In some cases, these local pressure and temperature elevations may persist for nano- or pico-seconds.

An approximation of energy input into the fluid (kW/L/min) can be estimated by measuring the motor energy (kW) and fluid output (L/min) As mentioned above, tip speed is the velocity (ft/min or m/s) associated with the end of the one or more revolving elements that is creating the mechanical force applied to the fluid. In embodiments, the energy expenditure is at least about 1000 W/m³, 5000 W/m³, 7500 W/m³, 1 kW/m³, 500 kW/m³, 1000 kW/m³, 5000 kW/m³, 7500 kW/m³, or greater. In embodiments, the energy expenditure of HSD 140/340 is greater than 1000 watts per cubic meter of fluid therein. In embodiments, the energy expenditure of HSD 140/340 is in the range of from about W/m³ to about 7500 kW/m³. In embodiments, the energy expenditure of HSD 140/340 is in the range of from about 3000 W/m³ to about 7500 W/m³. The actual energy input needed is a function of what reactions are occurring within the HSD, for example, endothermic and/or exothermic reaction(s), as well as the mechanical energy required for dispersing and mixing feedstock materials. In some applications, the degree of exothermic reaction(s) occurring within the HSD mitigates some or substantially all of the reaction energy needed from the motor input. When dispersing a gas in a liquid, the energy requirements are significantly less than when all reactants are liquid.

The shear rate is the tip speed divided by the shear gap width (minimal clearance between the rotor and stator). The shear rate generated in HSD 140/340 may be greater than 20,000 s⁻¹. In some embodiments the shear rate is at least 30,000 s⁻¹ or at least 40,000 s⁻¹. In some embodiments the shear rate is greater than 30,000 s⁻¹. In some embodiments the shear rate is at least 100,000 s⁻¹. In some embodiments the shear rate is at least 500,000 s⁻¹. In some embodiments the shear rate is at least 1,000,000 s⁻¹. In some embodiments the shear rate is at least 1,600,000 s⁻¹. In some embodiments the shear rate is at least 3,000,000 s⁻¹. In some embodiments the shear rate is at least 5,000,000 s⁻¹. In some embodiments the shear rate is at least 7,000,000 s⁻¹. In some embodiments the shear rate is at least 9,000,000 s⁻¹. In embodiments where the rotor has a larger diameter, the shear rate may exceed about 9,000,000 s⁻¹. In embodiments, the shear rate generated by HSD 140/340 is in the range of from 20,000 s⁻¹ to 10,000,000 s⁻¹. For example, in one application the rotor tip speed is about 40 m/s (7900 ft/min) and the shear gap width is 0.0254 mm (0.001 inch), producing a shear rate of 1,600,000 s⁻¹. In another application the rotor tip speed is about 22.9 m/s (4500 ft/min) and the shear gap width is 0.0254 mm (0.001 inch), producing a shear rate of about 901,600 s⁻¹.

In some embodiments, HSD 140/340 comprises a colloid mill. Suitable colloidal mills are manufactured by IKA® Works, Inc. Wilmington, N.C. and APV North America, Inc. Wilmington, Mass., for example. In some instances, HSD 140/340 comprises the DISPAX REACTOR® of IKA® Works, Inc.

In some embodiments, each stage of the external HSD has interchangeable mixing tools, offering flexibility. For example, the DR 2000/4 DISPAX REACTOR® of IKA® Works, Inc. Wilmington, N.C. and APV North America, Inc. Wilmington, Mass., comprises a three stage dispersing module. This module may comprise up to three rotor/stator combinations (generators), with choice of fine, medium, coarse, and super-fine for each stage. This allows for variance of shear rate along the direction of flow. In some embodiments, each of the stages is operated with super-fine generator.

In embodiments, a scaled-up version of the DISPAX® reactor is utilized. For example, in embodiments HSD 140/340 comprises a SUPER DISPAX REACTOR® DRS 2000. The HSD unit may be a DR 2000/50 unit, having a flow capacity of 125,000 liters per hour, or a DRS 2000/50 having a flow capacity of 40,000 liters/hour. Because residence time is increased in the DRS unit, the fluid therein is subjected to more shear. Referring now to FIG. 4, there is presented a longitudinal cross-section of a suitable device HSD 200 for use as HSD 140/340. HSD 200 of FIG. 4 is a dispersing device comprising three stages or rotor-stator combinations, 220, 230, and 240. The rotor-stator combinations may be known as generators 220, 230, 240 or stages without limitation. Three rotor/stator sets or generators 220, 230, and 240 are aligned in series along drive shaft 250.

First generator 220 comprises rotor 222 and stator 227. Second generator 230 comprises rotor 223, and stator 228. Third generator 240 comprises rotor 224 and stator 229. For each generator the rotor is rotatably driven by input 250 and rotates about axis 260 as indicated by arrow 265. The direction of rotation may be opposite that shown by arrow 265 (e.g., clockwise or counterclockwise about axis of rotation 260). Stators 227, 228, and 229 may be fixably coupled to the wall 255 of HSD 200. As mentioned hereinabove, each rotor and stator may comprise rings of complementarily-shaped tips, leading to several shear gaps within each generator.

As mentioned hereinabove, each generator has a shear gap width which is the minimum distance between the rotor and the stator. In the embodiment of FIG. 4, first generator 220 comprises a first shear gap 225; second generator 230 comprises a second shear gap 235; and third generator 240 comprises a third shear gap 245. In embodiments, shear gaps 225, 235, 245 have widths in the range of from about 0.025 mm to about 10 mm. Alternatively, the process comprises utilization of an HSD 200 wherein the gaps 225, 235, 245 have a width in the range of from about 0.5 mm to about 2.5 mm. In certain instances the shear gap width is maintained at about 1.5 mm. Alternatively, the width of shear gaps 225, 235, 245 are different for generators 220, 230, 240. In certain instances, the width of shear gap 225 of first generator 220 is greater than the width of shear gap 235 of second generator 230, which is in turn greater than the width of shear gap 245 of third generator 240. As mentioned above, the generators of each stage may be interchangeable, offering flexibility. HSD 200 may be configured so that the shear rate remains the same or increases or decreases stepwise longitudinally along the direction of the flow 260.

Generators 220, 230, and 240 may comprise a coarse, medium, fine, and super-fine characterization, having different numbers of complementary rings or stages on the rotors and complementary stators. Rotors 222, 223, and 224 and stators 227, 228, and 229 may be toothed designs. Each generator may comprise two or more sets of complementary rotor-stator rings. In embodiments, rotors 222, 223, and 224 comprise more than 3 sets of complementary rotor/stator rings.

HSD 140/340 may be a large or small scale device. In embodiments, system 100/300 is used to process from less than 100 gallons per minute to over 5000 gallons per minute. In embodiments, one or more HSD 140/340 processes at least 100, 500, 750, 900, 1000, 2000, 3000, 4000, 5000 gpm or more. Large scale units may produce 1000 gal/h (24 barrels/h). The inner diameter of the rotor may be any size suitable for a desired application. In embodiments, the inner diameter of the rotor is from about 12 cm (4 inch) to about 40 cm (15 inch). In embodiments, the diameter of the rotor is about 6 cm (2.4 inch). In embodiments, the outer diameter of the stator is about 15 cm (5.9 inch). In embodiments, the diameter of the stator is about 6.4 cm (2.5 inch). In some embodiments the rotors are 60 cm (2.4 inch) and the stators are 6.4 cm (2.5 inch) in diameter, providing a clearance of about 4 mm. In certain embodiments, each of three stages is operated with a super-fine generator comprising a number of sets of complementary rotor/stator rings.

HSD 200 is configured for receiving at inlet 205 a feed mixture from line 110/310. The feed comprises bitumen or heavy crude oil in the case of asphaltene removal or tailings in the case of water recovery. The feed may comprise reactant gas or reactant gas may be separately introduced into the HSD. Feed stream entering inlet 205 is pumped serially through generators 220, 230, and then 240, such that a dispersion is produced. High shear-treated product exits HSD 200 via outlet 210 (and lines 150/160 of FIGS. 1/2). The rotors 222, 223, 224 of each generator rotate at high speed relative to the fixed stators 227, 228, 229, providing a high shear rate. The rotation of the rotors pumps fluid, such as the feed stream entering inlet 205, outwardly through the shear gaps (and, if present, through the spaces between the rotor teeth and the spaces between the stator teeth), creating a localized high shear condition. High shear forces exerted on fluid in shear gaps 225, 235, and 245 (and, when present, in the gaps between the rotor teeth and the stator teeth) through which fluid flows process the fluid and create high shear product. The product comprises a high shear mixture (e.g. a dispersion) of reactant gas and feed. High shear-treated product exits HSD 200 via high shear outlet 210 (line 150/350 of FIGS. 1/2).

Without wishing to be limited by theory, it is believed that the high shear product at 210 may comprise an abundance of free radicals. The shear provided by the high velocity may generate numerous micronized or submicronized globules. The high velocity, associated surface phenomenon and other dissociating forces may generate the free radicals in the product. This high shear-treated product is highly reactive and may remain in a reactive state for substantial time periods, e.g. 30 minutes or more in some instances, even upon exiting the HSD.

As mentioned above, in certain instances, HSD 200 comprises a DISPAX REACTOR® of IKA® Works, Inc. Wilmington, N.C. and APV North America, Inc. Wilmington, Mass. Several models are available having various inlet/outlet connections, horsepower, tip speeds, output rpm, and flow rate. Selection of the HSD will depend on throughput selection, for example. IKA® model DR 2000/4, for example, comprises a belt drive, 4M generator, PTFE sealing ring, inlet flange 25.4 mm (1 inch) sanitary clamp, outlet flange 19 mm (¾ inch) sanitary clamp, 2HP power, output speed of 7900 rpm, flow capacity (water) approximately 300-700 L/h (depending on generator), a tip speed of from 9.4-41 m/s (1850 ft/min to 8070 ft/min) Scale up may be performed by using a plurality of HSDs, or by utilizing larger HSDs. Scale-up using larger models is readily performed, and results from larger HSD units may provide improved efficiency in some instances relative to the efficiency of lab-scale devices. The large scale unit may be a DISPAX® 2000/unit. For example, the DRS 2000/5 unit has an inlet size of 51 mm (2 inches) and an outlet of 38 mm (1.5 inches).

In embodiments HSD 140/340 or portions thereof are manufactured from refractory/corrosion resistant materials. For example, sintered metals, INCONEL° alloys, HASTELLOY® materials may be used. For example, when the mixture is or comprises caustic the rotors, stators, and/or other components of the HSD may be manufactured of refractory materials (e.g. sintered metal) in various applications.

Separation Apparatus 160/360.

As discussed hereinabove, the high shear system comprises a separation apparatus 160/360 configured to separate a component from the high shear-treated product stream introduced thereto via high shear-treated product stream outlet line 150/360. Separation units 160/360 may be selected from centrifuges, settling tanks, filtration units, and the like, as known in the art. In embodiments, separation unit 160/360 comprises one or more centrifuges. Separation apparatus 160/360 comprises an outlet 170/370 for removed component and an outlet for component-reduced product 180/380. Separation apparatus 160 may further comprise a gas outlet line 175 for removal of gas from separation apparatus 160. A recycle line may fluidly connect the gas outlet line of the separation apparatus with the HSD.

Separation unit 160/360 may be operable continuously, semi-continuously, or batchwise. Separation apparatus 160/360 may comprise one or more unit(s) configured in series or in parallel. For parallel operation, outlet line 150/350 may divide to introduce high shear-treated product into multiple units 160/360.

Settling Tank 390.

As indicated in FIG. 2 and discussed hereinabove, the high shear system may further comprise an additional separation unit, such as settling tank 390 in the embodiment of FIG. 2. High shear system 100/300 may comprise one or more settling tanks 390. Settling tank 390 is any suitable apparatus configured to provide a suitable residence time for the separation of an oil phase from an aqueous phase. Settling tank(s) 390 comprises an outlet 385 for an aqueous phase and an outlet 395 for an oil phase.

Feed Source 305.

As indicated in the embodiment of FIG. 2, the high shear system may further comprise feed source 305. Feed source 305 may comprise apparatus suitable for providing bitumen or heavy crude to HSD 140 in applications in which the high shear system is to be utilized for removal of asphaltenes or apparatus suitable for providing tailings to HSD 340 in applications in which the high shear system is to be utilized for enhanced water recovery/bitumen extraction. In embodiments, feed source 305 comprises apparatus suitable for providing tailings conventionally introduced into a tailings pond. In embodiments, feed source 305 comprises a tailings pond. In applications, feed source apparatus comprises a combination of the equipment shown in FIG. 3. The feed source may comprise, for example, one or more separation cells 24, one or more coarse centrifuges 40, one or more fine centrifuges 46, one or more secondary separation units 28 or a combination thereof. Feed source apparatus 305 may further comprise one or more tumblers 18, one or more hydrotransport lines and/or one or more froth breakers 34.

Heat Transfer Devices.

Internal or external heat transfer devices are also contemplated in variations of the system. For example, the reactants may be preheated via any method known to one skilled in the art. Some suitable locations for one or more such heat transfer devices are upstream of the HSD, between the HSD and flow line 150/350, and within or subsequent separation apparatus 160/360. HSD 140/340 may comprise an inner shaft which may be cooled, for example water-cooled, to partially or completely control the temperature within the HSD. Some non-limiting examples of such heat transfer devices are shell, tube, plate, and coil heat exchangers, as are known in the art.

Pumps.

The high shear system may comprise one or more pumps configured for either continuous or semi-continuous operation, and may be any suitable pumping device that is capable of providing controlled flow through HSD 140/340 and high shear system 100/300. In applications the one or more pump provides greater than 202.65 kPa (2 atm) pressure or greater than 303.97 kPa (3 atm) pressure. The one or more pump may be a Roper Type 1 gear pump, Roper Pump Company (Commerce Georgia) Dayton Pressure Booster Pump Model 2P372E, Dayton Electric Co (Niles, Ill.) is one suitable pump. Preferably, all contact parts of the pump comprise stainless steel, for example, 316 stainless steel. In some embodiments of the system, the one or more pump is capable of pressures greater than about 2026.5 kPa (20 atm).

In embodiments, a high shear system as described in the embodiment of FIG. 1 is incorporated into a hot water extraction system as depicted in FIG. 3. For example, one or more high shear system(s) may be incorporated into a hot water extraction process at locations indicated with arrows A, B, C, D and E, or elsewhere throughout an extraction system. In such embodiments, asphaltene removal may be provided by fluidly connecting a bitumen line, such as on line 20 (before or after pump 21) as indicated by arrows C and D, on line 30 as indicated by arrow E, 32, 38, 44, or 48 into HSD 140. A high shear system 100 may be incorporated as indicated at arrow B. In embodiments, a high shear system as described in the embodiment of FIG. 2 is incorporated into a hot water extraction system as depicted in FIG. 3. In such embodiments, water may be recovered from the tailings by introducing tailings from tailings pond 52 (feed source 305) into high shear system 300 as indicated at arrow A. In this manner, water may be more rapidly recovered and recycled to tumbler 18 and bitumen recovery may be enhanced. In embodiments, a high shear system(s) is incorporated at arrow C, D, and/or E. Each of the locations could optionally have addition of CO₂ and/or other compounds that cause the asphaltene to drop out after reacting in the high shear unit. One or more diluents, such as, but not limited to naphtha and propane, may be added along with heat at any point in the system/process to reduce viscosity and aid in transporting the bitumen. Such diluents may subsequently be removed and reused.

High Shear Method for Removing a Component from a Stream Produced During Recovery and/or Processing of Heavy Crude Oil or Bitumen.

A method of removing a component from a stream produced during recovery and/or treatment of heavy crude oil or bitumen will now be described with respect to FIG. 4 which is a schematic of a high shear method 400 of removing a desired component from a feed according to an embodiment of this disclosure. Method 400 comprises intimately contacting feed and gas to form a high shear-treated product at 410 and separating a component from the high shear-treated product at 420. For ease of description, a method of removing asphaltenes from asphaltenic bitumen or heavy crude oil will now be made separately from description of a method of improving bitumen extraction.

Method of Improving Bitumen Extraction from Tar Sands.

In embodiments, a high shear method is provided for improving bitumen extraction from tar sands. This method may be utilized to enhance bitumen separation from inorganic materials (mostly sand and clay) following excavation or extraction from the ground.

For example, with reference now to FIG. 3, which depicts a prior art hot water bitumen processing system, hot water and a conditioning agent or base (usually caustic soda; i.e. sodium hydroxide) are added to the bitumen to aid separation of the bitumen from the inorganic components. Other bases, such as sodium sesquicarbonate, may also be utilized. (See, for example, U.S. Pat. App. No. 2002/0104799 by Humphreys et al.) Hot water processing is usually performed in large tumblers 16 to aid in mixing. The slurry from the tumblers 16 is screened through screen 22 to separate the larger debris and passed to a separating cell 24 where settling time is provided to allow the slurry to separate. As the slurry settles, the bitumen froth rises to the surface and the sand particles and sediments fall to the bottom. A middle viscous sludge layer, termed middlings, contains dispersed clay particles and some trapped bitumen which is not able to rise due to the viscosity of the sludge. Once the slurry has settled, the froth is skimmed off via line 30 for froth treatment and the sediment layer is passed via line 27 to a tailings pond 52. The middlings 26 may be fed to a second stage 28 of froth floatation for further bitumen froth recovery. Tailings from secondary separation 28 may be sent via line 51 to tailings pond 52.

In other embodiments, a modified hot water extraction process termed the hydrotransport process is used to mix tar sand with hot water and caustic at the mine site and the resultant slurry is transported to the extraction unit 24 in a large pipe. During the hydrotransport tar sand is conditioned and the bitumen is aerated to form a froth. The hydrotransport system replaces the manual or mechanical transport of the tar sands to the extraction unit and eliminates the need for tumblers 16.

The bitumen froth in line 30 from either process contains bitumen, solids and trapped water. The solids which are present in the froth are in the form of clays, silt and some sand. From the separating cell 24 the froth is passed via a line 30 to a defrother vessel 34 where the froth is heated and broken to remove the air. Naphtha is then added via line 33 to cause a reduction in the density of the bitumen, facilitating separation of the bitumen from the water by means of a subsequent centrifuge treatment. The centrifuge treatment first includes a gross centrifuge separation in coarse centrifuge 40 followed by fine centrifuge 46. The bitumen collected from the centrifuge treatment 48 may contain less than 2% water and solids and can be passed to the refinery for upgrading. The water and solids released during the centrifuge treatment and extracted from coarse centrifuge 40 via line 42 and extracted from fine centrifuge 46 via line 50 may also be passed to the tailings pond.

Typically, the tailings in a conventional tailing pond comprise a sludge of caustic soda, sand and water with some bitumen. During the initial years of residence time, some settling takes place in the upper layer of the pond, releasing some of the trapped water. The water released from the ponds can be recycled back into the hot water process. The major portion of the tailings remains as sludge indefinitely. The sludge contains some bitumen and high percentages of solids, mainly in the form of suspended silt and clay.

The tailings ponds are costly to build and maintain. The size of the ponds and their characteristic caustic condition creates serious environmental problems. In addition, environmental concerns exist over the large quantity of water which is required for extraction and which remains locked in the tailings pond after use.

It is known that sludge is formed in the initial conditioning of the tar sand, when the caustic soda attacks the sand and clay particles. The caustic soda causes the clays to swell and disburse into platelets which remain dispersed, inhibiting settling. These platelets are held in suspension and form the gel-like sludge. Such sludge inhibits the floatation of the bitumen froth in the extraction process. Expanding-type clays such as the montmorillanite clays are particularly susceptible to caustic attack. Because of the problems caused by sludge formation and the low bitumen recovery available from highly viscous sludges, lower grade tar sands containing high levels of expanding-type clays cannot be treated satisfactorily using the conventional hot water extraction process.

The disclosed extraction process allows a reduction in the production of sludge and therefore an increase in the water available for recycling. Such a process provides the possibility of increased bitumen recovery from lower grade ores. According to this embodiment, intimately contacting a feed with gas to form a high shear-treated product 410 comprises intimately contacting a feed comprising tailings with carbon dioxide gas to form a high shear-treated product. The high shear contacting of the tailings with carbon dioxide transforms the caustic soda added to the bitumen mix to sodium carbonate and then to sodium bicarbonate, enhancing the settling rate and facilitating separation of recyclable water. Settling aids may be added at any point in the process where settling needs to be enhanced. Settling aids such as polyacrylate and polyacrylamide polymers and alum and their application are known to those experienced in the art.

The CO₂ can be of any source and need not be pure. CO₂ can be sourced from combustion off-gas such as boiler and petrochemical plants with the added benefit of sequestering a known greenhouse gas. CO₂ may optionally be mixed with air to aid in flotation where a froth formation is desirable. Addition of frothing aids, such as surface active agents, is also contemplated if enhanced froth formation is desired. Froth formation may aid separation of more dense from less dense compounds by attaching bubbles to the insoluble compounds in the bitumen mix. Lignisulfonate and sulfosuccinate are among the known surface active agents used to aid in froth formation. Many other suitable compounds are known to those experienced in the art.

As discussed above, the feed (e.g. tailings) may be obtained by any means known in the art, for example as described hereinabove with respect to the prior art hot water process of FIG. 3. In this embodiment, intimately mixing at 410 comprises subjecting the feed mixture (tailings), which may be introduced from tailings pond 305, to high shear in the presence of carbon dioxide, which may be introduced via reactant gas line 320 or may be introduced directly into HSD 340, to produce a high shear-treated product. With respect to FIG. 2, the high shear-treated stream exiting HSD 340 via line 350 may be in the form of a dispersion of carbon dioxide bubbles in the tailings. The bubbles may have a mean diameter in the micron or submicron range, may have a mean diameter of less than about 1 μm, less than 0.5 μm, or less than 0.4 μm. In embodiments, subjecting the feed mixture to high shear comprises subjecting to a shear rate of at least 10,000 s⁻¹, at least 20,000 s⁻¹, at least 30,000 s⁻¹, or higher, as further discussed herein.

As mentioned above, subjecting the feed mixture and carbon dioxide to high shear may produce a dispersion comprising carbon dioxide dispersed throughout a liquid phase comprising tailings. In embodiments, a dispersion comprising nanobubbles and/or microbubbles of the reactant gas is formed. In embodiments, the bubbles in the dispersion have an average diameter of less than or about 5, 4, 3, 2 or 1 μm. In embodiments, the bubbles in the dispersion have an average particle diameter in the nanometer range, the micron range, or the submicron range.

Referring now to FIG. 2, intimately mixing the feed mixture and reactant gas at 410 comprises introducing the feed mixture into HSD 340. The feed mixture may be pumped into HSD 340. Carbon dioxide may be introduced into HSD 340 via one or more dispersible gas lines 320 or may be introduced directly into HSD 340. As discussed above, the reactant gas may be any suitable and available gas stream comprising carbon dioxide. In embodiments, the reactant gas is substantially pure carbon dioxide. In embodiments, the reactant gas further comprises air, for example, to aid in flotation and separation of oil. Reactant gas may be introduced into line 310 via line 320 or may be introduced elsewhere throughout high shear system 300. In embodiments, reactant gas is introduced into line 310 via line 320. In embodiments, reactant gas and feed comprising tailings are separately introduced directly into HSD 340. The feed mixture may be pumped through line 310, to build pressure and feed HSD 340, providing a controlled flow throughout HSD 340 and high shear system 300. In some embodiments, the pressure of the HSD inlet stream in line 310 is increased to greater than 200 kPa (2 atm) or greater than about 300 kPa (3 atmospheres). In this way, high shear system 300 may combine high shear with pressure to enhance production of bicarbonate and separation and recovery of water.

Within high shear device 340, the feed comprising tailings is intimately contacted with carbon dioxide. The temperature, shear rate and/or residence time within HSD 340 may be controlled to effect desired reaction and provide a sufficient but not excessive amount of carbon dioxide. Desirably, the amount of carbon dioxide introduced into the HSD is sufficient such that the pH of the solution drops to below 6. In embodiments, the feed has a pH of about 10 and the pH of the high shear-treated stream is less than about 6, such that solids and oil are easily removed from the water via centrifuge 360 and settling tank 395, respectively. It is noted that shearing in the presence of air (present in the system or introduced thereto along with reactant carbon dioxide gas) may also enhance the flotation of the oil in settling tank 390. In some aspects of the present invention the high shear device will cause formation of micelles due to the presence of surface active agents in the bitumen mix. Micelle formation may aid in bitumen mix flow and will be broken once water is removed.

In an exemplary embodiment, the high shear device comprises a commercial disperser such as IKA® model DR 2000/4, a high shear, three stage dispersing device configured with three rotors in combination with stators, aligned in series, as described above. The disperser is operated to subject the contents to high shear. The rotor/stator sets may be configured as illustrated in FIG. 4, for example. In such an embodiment, the feed comprising tailings enters high shear device 340 via line 310 and enters a first stage rotor/stator combination having circumferentially spaced first stage shear openings. The coarse mixture exiting the first stage enters the second rotor/stator stage, which has second stage shear openings. The mixture emerging from the second stage enters the third stage rotor/stator combination having third stage shear openings. The rotors and stators of the generators may have circumferentially spaced complementarily-shaped rings. A high shear-treated product exits the high shear device via outlet 210 (line 350 in FIG. 2).

In some embodiments, the shear rate increases stepwise longitudinally along the direction of the flow 260, or going from an inner set of rings of one generator to an outer set of rings of the same generator. In other embodiments, the shear rate decreases stepwise longitudinally along the direction of the flow, 260, or going from an inner set of rings of one generator to an outer set of rings of the same generator (outward from axis 200). For example, in some embodiments, the shear rate in the first rotor/stator stage is greater than the shear rate in subsequent stage(s). For example, in some embodiments, the shear rate in the first rotor/stator stage is greater than or less than the shear rate in a subsequent stage(s). In other embodiments, the shear rate is substantially constant along the direction of the flow, with the stage or stages being the same. If HSD 340 includes a PTFE seal, for example, the seal may be cooled using any suitable technique that is known in the art. The HSD may comprise a shaft in the center which may be used to control the temperature within HSD 340.

The rotor(s) of HSD 340 may be set to rotate at a speed commensurate with the diameter of the rotor and the desired tip speed. As described above, the HSD (e.g., colloid mill or toothed rim disperser) has either a fixed clearance between the stator and rotor or has adjustable clearance.

In some embodiments, HSD 340 delivers at least 300 L/h at a nominal tip speed of at least 22 m/s (4500 ft/min), 40 m/s (7900 ft/min), and which may exceed 225 m/s (45,000 ft/min) or greater. The power consumption may be about 1.5 kW or higher as desired. Although measurement of instantaneous temperature and pressure at the tip of a rotating shear unit or revolving element in HSD 340 is difficult, it is estimated that the localized temperature seen by the intimately mixed reactants may be in excess of 500° C. and at pressures in excess of 500 kg/cm² under high shear conditions.

Conditions of temperature, pressure, space velocity, and/or ratio of reactant gas to tailings may be adjusted to effect substantially complete conversion of caustic in the tailings to bicarbonate, enhancing subsequent component separation. The global temperature and/or the temperature of the feed mixture introduced into HSD 340 may be in the range of from about 5° C. to about 95° C. In embodiments, the global temperature is ambient temperature. In embodiments, the global operating temperature is room temperature.

The residence time within HSD 340 is typically low. For example, the residence time can be in the millisecond range, can be about 10, 20, 30, 40, 50, 60, 70, 80, 90 or about 100 milliseconds, can be about 100, 200, 300, 400, 500, 600, 700, 800, or about 900 milliseconds, can be in the range of seconds, or can be any range thereamong.

As mentioned above, intimately mixing the feed mixture comprising tailings with the carbon dioxide may comprise running the feed mixture through one or more HSDs 340. Intimately mixing the feed mixture with carbon dioxide at 410 may comprise running the feed mixture through two or more HSDs 340, in series or in parallel. Intimately mixing the feed mixture with carbon dioxide may comprise running the feed mixture through three or more HSDs 340, in series and/or in parallel. Additional carbon dioxide may be introduced into each subsequent HSD.

In this embodiment, separating a component from the high shear-treated product at 420 comprises introducing the high shear-treated stream into a centrifuge 360. Centrifuge 360 is operated to separate solids from liquid. Solids are removed from centrifuge 360 via solids outlet line 370. Separating a component from the high shear-treated product at 420 further comprises introducing the solids-reduced product into settling tank 390 via line 380. Within settling tank 390, an aqueous phase 385 is separated from an oil phase 395. The oil phase in line 395 may be combined with product bitumen in line 30 or 48 of FIG. 3, for example, when high shear system 300 is incorporated into such a hot water caustic bitumen extraction process.

The high shear contacting of the tailings with carbon dioxide reduces settling times for the sludge (tailings). When carbon dioxide is added with shear, the caustic present in the water from the tailings gets converted to sodium bicarbonate. As disclosed in U.S. Pat. No. 5,626,743, which is hereby incorporated herein by reference for all purposes not contrary to this disclosure, the clay settles faster in the presence of bicarbonate than caustic. The shear and carbon dioxide forces the oil out of the clay. The oil may be floated to the top of settling tank 390 and removed, for example, skimmed off the surface. The presence of air may aid in the flotation of oil in settling tank 390. The water removed via line 385 may be sent for further treatment, for example to a bio-pond, prior to discharge or may be recycled to the bitumen extraction process, minimizing the amount of fresh water needed for processing relative to conventional methods.

In embodiments, the water removed via line 385 comprises less than 1 wt %, less than 0.5 wt %, or less than 0.1 wt % TSS. This water may be aerated, treated and discharged or recycled back to process.

Method of Removing Asphaltenes from Heavy Crude Oil/Bitumen.

The high shear method will now be described with reference to the removal of asphaltenes from asphaltenic oil. The asphaltenic oil may comprise heavy crude oil or bitumen. Description of this method will now be provided with reference to FIGS. 1 and 3. Asphaltenes are complex organic materials that are arranged in stacked, multi-ring structures that posses very high boiling point polyaromatic hydrocarbons. The exact molecular structure of asphaltenes is not known because of the complexity of the asphaltene molecules. Therefore, the definitions of asphaltenes are based on their solubility. Generally, asphaltenes are the fraction of oil that is insoluble in paraffinic solvents such as n-heptane or n-pentane, and soluble in aromatic solvents such as benzene or toluene. Asphaltenes contain nitrogen, sulfur and oxygen atoms in addition to carbon and hydrogen atoms within the repeating unit. Asphaltenes are not truly soluble in crude oil. They exist as 35-40 micron platelets that are maintained in suspension by materials known as maltenes and resins. When stabilizing factors are altered, the asphaltenes coalesce under certain pressure, temperature and compositional conditions. It is generally understood that the API gravity goes down with increasing asphaltene content.

The major destabilizing forces for asphaltenes, as described in the book Asphaltene and Asphalts (Yen and Chilingar—1994), include CO₂ injection, miscible flooding, pH shift, mixing of crude streams, and the presence of incomplete organic chemicals. The role of carbon dioxide in destabilizing asphaltene-crude oil is well-documented. Some degree of asphaltene precipitation is noted in wells in every CO₂ flooding operation, with the most notable asphaltene precipitation being in the well-bore and the pump regions. Miscible flooding causes asphaltene destabilization because straight chain hydrocarbons have less affinity for asphaltene ring structures. In analytical tests, heptane is normally used in crude oil to reject asphaltene. A shift in pH can be invoked by CO₂, mineral acids or naturally occurring acids and can destabilize asphaltenes. Asphaltene precipitation can also be induced by high shear or perturbation caused by cavitations in some pumps or mixing manifolds. Some chemicals, such as methyl alcohol which does not have an aromatic ring, may selectively attract or wet the maltenes or resins and cause agglomeration of asphaltenes.

In this embodiment, the high shear method is utilized to effect enhanced removal of asphaltenes from asphaltenic oil by subjecting the asphaltenic oil to high shear in the presence of carbon dioxide. In this embodiment, intimately contacting feed with gas to form high shear-treated product 410 comprises intimately mixing feed comprising asphaltenic heavy crude oil and/or bitumen (i.e., heavy crude oil comprising asphaltenes and/or bitumen comprising asphaltenes) with carbon dioxide. The intimate contacting may be performed substantially as described above. With reference to FIG. 1, bitumen or heavy crude oil is introduced into HSD 140 along with carbon dioxide. Water may be added to HSD 140 in some applications. High shear-treated product exits HSD 140 via HSD outlet line 150.

Specifically, the feed (bitumen or heavy crude oil) may be obtained by any means known in the art, for example a bitumen feed may be obtained as described hereinabove with respect to the prior art hot water bitumen extraction process of FIG. 3. In this embodiment, intimately mixing at 410 comprises subjecting the feed mixture (comprising bitumen or heavy crude oil) to high shear in the presence of carbon dioxide, which may be introduced via reactant gas line 120, may already be present in the feed, or may be introduced into the feed prior to introduction of the feed into HSD 140, to produce a high shear-treated product. As indicated in FIG. 1, water may be introduced into HSD 140 via separate inlet line 130 or may be combined with or present in feed 110. With respect to FIG. 1, the high shear treated stream exiting HSD 140 via line 150 may be in the form of a dispersion of carbon dioxide in the feed or feed/water mixture. In embodiments, subjecting the feed mixture to high shear comprises subjecting to a shear rate of at least 10,000 s⁻¹, at least 20,000 s⁻¹, at least 30,000 s⁻¹, or higher, as further discussed herein.

Referring again to FIG. 1, intimately mixing the feed mixture and reactant gas at 410 comprises introducing the feed mixture into HSD 140. The feed mixture may be pumped into HSD 140. Carbon dioxide may be introduced into HSD 140 via one or more dispersible gas lines 120 or may be introduced directly into HSD 140, as indicated. As discussed above, the reactant gas may be any suitable and available gas stream comprising carbon dioxide. In embodiments, the reactant gas is substantially pure carbon dioxide. Reactant gas may be introduced into line 110 or may be introduced elsewhere throughout high shear system 100. In embodiments, reactant gas is introduced into line 110 prior to introduction into HSD 140. In embodiments, reactant gas and feed comprising asphaltenic oil from which asphaltenes are to be removed are separately introduced directly into HSD 140. The feed mixture may be pumped through line 110, to build pressure and feed HSD 140, providing a controlled flow throughout high shear device (HSD) 140 and high shear system 100. In some embodiments, the pressure of the HSD inlet stream in line 110 is increased to greater than 200 kPa (2 atm) or greater than about 300 kPa (3 atmospheres). In this way, high shear system 100 may combine high shear with pressure to enhance destabilization and subsequent separation of asphaltenes from the feed oil.

Within high shear device 140, the feed comprising asphaltenic oil is intimately mixed with carbon dioxide. The temperature, shear rate and/or residence time within HSD 140 may be controlled to effect desired asphaltene destabilization and provide a sufficient but not excessive amount of carbon dioxide. Experiments may be performed to determine the minimum amount of carbon dioxide needed to effect a desired degree of asphaltene removal.

Subjecting the feed mixture and carbon dioxide to high shear may produce a dispersion comprising carbon dioxide dispersed throughout a liquid phase. In embodiments, a dispersion comprising nanobubbles and/or microbubbles of the reactant gas is formed. In embodiments, the bubbles in the dispersion have an average diameter of less than or about 5, 4, 3, 2 or 1 μm. In embodiments, the bubbles in the dispersion have an average particle diameter in the nanometer range, the micron range, or the submicron range. In embodiments, hydrogen is also introduced to the high shear device to enable hydrogenation, in a manner similar to that provided in U.S. Pat. App. No. 61/145,839, which is hereby incorporated herein by reference. Addition of hydrogen may aid in reducing viscosity and/or stabilizing the bitumen.

In an exemplary embodiment, the high shear device comprises a commercial disperser such as IKA® model DR 2000/4, a high shear, three stage dispersing device configured with three rotors in combination with stators, aligned in series, as described above. The disperser is operated to subject the contents to high shear. The rotor/stator sets may be configured as illustrated in FIG. 4, for example. In such an embodiment, the feed comprising asphaltenic oil enters high shear device 140 via line 110 and enters a first stage rotor/stator combination having circumferentially spaced first stage shear openings. The coarse mixture exiting the first stage enters the second rotor/stator stage, which has second stage shear openings. The mixture emerging from the second stage enters the third stage rotor/stator combination having third stage shear openings. The rotors and stators of the generators may have circumferentially spaced complementarily-shaped rings. A high shear-treated product exits the high shear device via outlet 210 (line 150 in FIG. 1).

In some embodiments, the shear rate increases stepwise longitudinally along the direction of the flow 260, or going from an inner set of rings of one generator to an outer set of rings of the same generator. In other embodiments, the shear rate decreases stepwise longitudinally along the direction of the flow, 260, or going from an inner set of rings of one generator to an outer set of rings of the same generator (outward from axis 200). For example, in some embodiments, the shear rate in the first rotor/stator stage is greater than the shear rate in subsequent stage(s). For example, in some embodiments, the shear rate in the first rotor/stator stage is greater than or less than the shear rate in a subsequent stage(s). In other embodiments, the shear rate is substantially constant along the direction of the flow, with the stage or stages being the same. If HSD 140 includes a PTFE seal, for example, the seal may be cooled using any suitable technique that is known in the art. The HSD may comprise a central shaft which may be used to control the temperature within HSD 140.

The rotor(s) of HSD 140 may be set to rotate at a speed commensurate with the diameter of the rotor and the desired tip speed. As described above, the HSD (e.g., colloid mill or toothed rim disperser) has either a fixed clearance between the stator and rotor or has adjustable clearance.

In some embodiments, HSD 140 delivers at least 300 L/h at a nominal tip speed of at least 22 m/s (4500 ft/min), 40 m/s (7900 ft/min), and which may exceed 225 m/s (45,000 ft/min) or greater. The power consumption may be about 1.5 kW or higher as desired. Although measurement of instantaneous temperature and pressure at the tip of a rotating shear unit or revolving element in HSD 140 is difficult, it is estimated that the localized temperature seen by the intimately mixed reactants may be in excess of 500° C. and at pressures in excess of 500 kg/cm² under high shear conditions.

Conditions of temperature, pressure, space velocity, and/or ratio of reactant gas to feed oil may be adjusted to effect substantially complete destabilization and subsequent removal of asphaltenes. The global temperature and/or the temperature of the feed mixture introduced into HSD 140 may be in the range of from about 10° C. to about 200° C. In embodiments, the global temperature is ambient temperature. In embodiments, the global operating temperature is room temperature.

The residence time within HSD 140 is typically low. For example, the residence time can be in the millisecond range, can be about 10, 20, 30, 40, 50, 60, 70, 80, 90 or about 100 milliseconds, can be about 100, 200, 300, 400, 500, 600, 700, 800, or about 900 milliseconds, can be in the range of seconds, or can be any range thereamong.

As mentioned above, intimately mixing the feed mixture comprising asphaltenic oil with the carbon dioxide may comprise running the feed mixture through one or more HSDs 140. Intimately mixing the feed mixture with carbon dioxide at 410 may comprise running the feed mixture through two or more HSDs 140, in series or in parallel. Intimately mixing the feed mixture with carbon dioxide may comprise running the feed mixture through three or more HSDs 140, in series and/or in parallel. Additional carbon dioxide may be introduced into each subsequent HSD.

In this embodiment, separating a component from the high shear-treated product 420 comprises introducing the high shear-treated product in line 150 into centrifuge 160. The high shear and the presence of CO₂ destabilize the asphaltenes, which are easily separated from the oil via operation of centrifuge 160. Asphaltenes are removed from centrifuge 160 via outlet line 170 and may be sent for further processing as known in the art. Oil from which asphaltenes have been removed (i.e. lighter crude oil or asphaltene-reduced bitumen) is removed from centrifuge 160 via line 180. Due to the removal of asphaltenes, the API gravity of the product oil in line 180 is generally greater than the API gravity of the feed oil (e.g. asphaltenic bitumen or heavy crude oil) introduced into high shear system 100 via feed line 110. In embodiments, the API gravity of the oil in line 180 is greater than about 7, greater than about 12, greater than about 15, or greater than about 17. In embodiments, the API gravity of the feed in line 110 is less than about 10, less than about 7 or less than about 5. Transportation of the asphaltene-reduced oil removed from centrifuge 160 via line 180 is thus facilitated relative to transport of the heavy crude oil or asphaltic bitumen introduced into high shear system 100 via line 110. Carbon dioxide may be removed from centrifuge 160 via gas outlet line 175. The carbon dioxide may be recycled to HSD 140.

Desirably, this process is performed subsequent removal of the majority of the clay, sand and other inorganics from the tar sands. For example, as indicated in FIG. 3, HSD 140 may be positioned downstream of one or more tumblers 18, downstream of one or more screens 22, downstream of one or more separation cells 24, and/or downstream of one or more secondary separation cells 28.

In embodiments, the operating temperature and pressure for asphaltene removal are mild. In embodiments, the operating temperature throughout high shear system 300 and/or HSD 140 is in the range of from about room temperature to about 100° C. In embodiments, the operating pressure is in the range if from about 0 to about 60 psig. The resulting liquid oil in product line 180 can be easily transported in pipelines with or without diluents. Advantages to this method of asphaltene removal may include: (1) a reduction in distillation cost of conventionally-used diluent; (2) a reduction in transportation cost of diluents; (3) removal of sand, clay and other inorganic contaminants from feed (e.g. heavy crude oil) along with removal of asphaltenes; (4) asphaltene removal in situ; (5) concomitant reduction in heavy metals; (6) reduction in pipeline fouling and cleaning costs due to sand asphaltene precipitation; (7) partial sulfur removal; and (8) operation in the presence or absence of water (as mentioned hereinabove, conventional solvent deasphalting is intolerant to the presence of water).

In embodiments, the product oil exiting the high shear system comprises less than 10 wt %, 5 wt %, 3 wt %, or 1 wt % of impurities selected from asphaltenes, sand, silt and other solids. In embodiments, the product oil in line 180 comprises from about 95 to about 99 wt % bitumen, from about 5 wt % to about 1 wt % water, and from about 2% to about 0.5 wt % solids. In embodiments, the product oil in line 180 comprises less than 10 wt %, 3 wt %, or 1 wt % asphaltenes. In embodiments, the product oil in line 180 comprises less than 1 wt %, 0.5 wt %, or 0.1 wt % solids, such as silt, sand, fines and other particulate matter (TDS). In embodiments, the product oil in line 180 comprises less than 5 wt %, 2 wt %, or 1 wt % water. In embodiments, the product oil has an API gravity of greater than 8, 10, or 15. In embodiments, the feed comprising bitumen or heavy crude oil introduced into HSD via feed line 110 has an API gravity in the range of from about 7 to about 10, from about 10 to about 15, or from about 15 to about 25. In embodiments, utilization of the disclosed system and method provides at least about a 30, 40, 50, 60, 70, or 80% reduction in the amount of impurities (e.g., asphaltenes, solids, water or heavy metals) in the bitumen or heavy crude oil fed to HSD 140 via line 110. Concomitantly, utilization of the disclosed system and method may provide a significant cost savings by providing for less required downstream purification equipment, reduced-size equipment, and/or reduced down-time for cleaning due to plugging, etc. The system and method may be operable to provide greater than 5, 10, or 20 tons/h of component reduced oil in line 180, 380 and/or 395.

Multiple Pass Operation.

In the embodiments shown in FIGS. 1 and 2, the systems are configured for single pass operation. However, the output of HSD 140/340 may be run through a subsequent HSD. In some embodiments, it may be desirable to pass the contents of flow line 150/350, flow line 180/380 or a fraction thereof, through HSD 140/340 during a second pass. In this case, at least a portion of the contents of flow line 150/350 or 180/380 may be recycled back into HSD 140/340. Additional reactant gas (e.g., carbon dioxide) may be injected via line 120/320 into line 110, or may be added directly into the HSD. Due to the rapidity of the interactions within the HSD, multiple pass operation may not be necessary or desirable.

Multiple HSDs.

In embodiments, high shear-treated product in HSD outlet line 150/350 or centrifuge 160/360 product outlet line 180/380 is fed into a second HSD. In some embodiments, two or more HSDs like HSD 140/340, or configured differently, are aligned in series, and are used to promote further interaction. In embodiments, the reactants pass through multiple HSDs 140/340 in serial or parallel flow. In embodiments, a second HSD is positioned upstream or downstream of centrifuge 160/360, whereby the high shear-treated product exiting HSD 140/340 or exiting centrifuge 160/360 via product outlet line 180/380 is introduced into a subsequent HSD for further treatment. When multiple HSDs are operated in series, additional carbon dioxide-containing gas may be injected into the inlet feedstream of each HSD. For example, additional reactant gas may be introduced into a second or subsequent HSD. In some embodiments, multiple HSDs are operated in parallel, and the outlet products therefrom are introduced into one or more flow lines 150/350.

Features.

Without wishing to be limited to a particular theory, it is believed that the level or degree of high shear mixing may be sufficient to increase rates of mass transfer and also produce localized non-ideal conditions (in terms of thermodynamics) that enable reactions to occur that would not otherwise be expected to occur based on Gibbs free energy predictions and/or increase the rate or extent of expected reactions. Localized non ideal conditions are believed to occur within the HSD resulting in increased temperatures and pressures with the most significant increase believed to be in localized pressures. The increases in pressure and temperature within the HSD are instantaneous and localized and quickly revert back to bulk or average system conditions once exiting the HSD. Without wishing to be limited by theory, in some cases, the HSD may induce cavitation of sufficient intensity to dissociate one or more of the reactants into free radicals, which may intensify a chemical reaction or allow a reaction to take place at less stringent conditions than might otherwise be required. Cavitation may also increase rates of transport processes by producing local turbulence and liquid micro-circulation (acoustic streaming). An overview of the application of cavitation phenomenon in chemical/physical processing applications is provided by Gogate et al., “Cavitation: A technology on the horizon,” Current Science 91 (No. 1): 35-46 (2006). The HSD of certain embodiments of the present system and methods may induce cavitation whereby one or more reactant is dissociated into free radicals, which then react. In embodiments, the extreme pressure at the tips of the rotors/stators leads to liquid phase reaction, and no cavitation is involved.

Various dimensions, sizes, quantities, volumes, rates, and other numerical parameters and numbers have been used for purposes of illustration and exemplification of the principles of the invention, and are not intended to limit the invention to the numerical parameters and numbers illustrated, described or otherwise stated herein. Likewise, unless specifically stated, the order of steps is not considered critical. The different teachings of the embodiments discussed herein may be employed separately or in any suitable combination to produce desired results.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, and so forth). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The disclosures of all patents, patent applications, and publications cited herein are hereby incorporated by reference, to the extent they provide exemplary, procedural or other details supplementary to those set forth herein.

What is claimed is:

1. A method of removing at least one component from a feed stream comprising tar sands tailings, asphaltenic oil, or a combination thereof, the method comprising:
subjecting the feed stream to high shear separation in a high shear device to produce a high shear-treated product stream; and
substantially separating the at least one component from the high shear-treated product stream to produce a component-reduced product stream.

2. The method of claim 1, wherein the feed stream is liquid phase, wherein the feed comprises the at least one component suspended therein, and wherein the high shear device operates to subject the feed to a shear rate of at least 20,000 s⁻¹.

3. The method of claim 1, wherein the feed stream is substantially liquid phase, and wherein subjecting the feed stream to high shear comprises introducing the feed stream a high shear device comprising at least one rotor and at least one complementarily-shaped stator.

4. The method of claim 4, wherein the high shear device is configured to operate with a tip speed of the rotor of at least about 23 msec.

5. The method of claim 1, wherein the tar sands tailings result from a caustic bitumen extraction process, and wherein the component-reduced product comprises water having less than 10 wt % impurities.

6. The method of claim 5, wherein substantially separating the at least one component comprises separating solids from the high shear-treated product to produce a solids-reduced product and separating an oil phase from the solids-reduced product to produce the component-reduced product, wherein the component-reduced product comprises water.

7. The method of claim 5, wherein the tailings fed to the high shear device are obtained from a tailings pond of the caustic bitumen extraction process.

8. The method of claim 1, wherein the component-reduced product stream comprises asphaltene-reduced oil.

9. The method of claim 8, wherein substantially separating the at least one component from the high shear-treated product to produce a component-reduced product comprises introducing the high shear-treated product into a centrifuge operated to separate asphaltenes from asphaltene-reduced product oil.

10. The method of claim 8 wherein the asphaltene-reduced product oil comprises less than about 5 wt % water, less than about 1 wt % solids, or both.

11. In an aqueous bitumen extraction process comprising treating a bitumen froth, the improvement comprising:
subjecting the bitumen froth to high shear in a substantially gas-free environment to produce a high shear treated product;
separating solids from the high shear treated product to produce a solids-reduced product;
separating water from the solids-reduced product; and
recycling the water to the high shear step.

12. A system for removing at least one component from a feed stream comprising tar sand tailings, asphaltenic oil, or a combination thereof, the system comprising:
at least one high shear device comprising at least one rotor and at least one complementarily-shaped stator and configured to subject the feed stream to high shear and produce a high shear-treated product, wherein the at least one high shear device is configured to subject the contents therein to a shear rate of at least 10,000 s⁻¹; and
at least one separation unit configured to separate a component from the high shear-treated product, providing a component-reduced product.

13. The system of claim 12, wherein the at least one rotor is configured to provide a tip speed of at least about 40 msec.

14. The system of claim 13, wherein the feed stream comprises tar sand tailings produced from a bitumen extraction process, wherein the at least one component comprises solids and oil, and wherein the system comprises a first separation unit configured to separate solids from the high shear-treated product producing a solids-reduced product and a second separation unit configured to separate oil from the solids-reduced product providing substantially pure water as component-reduced product.

15. The system of claim 13, wherein the at least one component comprises asphaltenes, and wherein the component-reduced product comprises asphaltene-reduced oil.

16. The system of claim 15 wherein the asphaltene-reduced oil further comprises less than about 5 wt % solids, less than 5 wt % water or both.

17. A method for removing contaminants from feedwater, the method comprising:
subjecting the feedwater to high shear separation in a high shear device to produce a high shear-treated product; and
using a separator to remove at least some contaminants from the high shear-treated product to produce a contaminant-reduced product.

18. The method of claim 17, wherein the feedwater comprises waste water, surface water, groundwater, or a combination thereof.

19. The method of claim 18, wherein the contaminant is selected from the group consisting of hydrogen sulfide, hydrocarbons, particulate matter, bacteria, and volatile components.

20. The method of claim 19, wherein the high shear device operates at a shear rate of greater than about 20,000 s⁻¹.

21. The method of claim 19, wherein the high shear device comprises at least one rotor, and wherein the at least one rotor is rotated at a tip speed of at least 22.9 m/s (4,500 ft/min) during operation.

22. The method of claim 21, wherein the high shear device produces a local pressure of at least about 1034.2 MPa (150,000 psi) at the tip of the at least one rotor during operation.

23. A system for treating feedwater to remove contaminants therefrom, the system comprising:
at least one high shear mixing device comprising at least one generator comprising a rotor and a stator separated by a shear gap, wherein the shear gap is the minimum distance between the rotor and the stator, and wherein the high shear mixing device is capable of producing a tip speed of the rotor of greater than 22.9 m/s (4,500 ft/min); and
a pump configured for delivering feedwater to the high shear mixing device.

24. The system of claim 23, further comprising a tank from which treated water is extracted, an inlet of the tank fluidly connected to the outlet of the high shear device.

25. The system of claim 23, wherein the high shear device comprises at least two generators.

26. The system of claim 25, wherein the shear rate provided by one generator is greater than the shear rate provided by another generator.
